(19) United States
(12) Patent Application Publication
(10) Pub. No.: US 2023/0033434 A1
(43) Pub. Date: Feb. 2, 2023

(54) SYSTEM AND METHOD FOR MANAGING ACCESS TO ONLINE DIGITAL COLLECTIBLES

(71) Applicant: Dapper Labs Inc., Vancouver (CA)

(72) Inventors: Benny GIANG, New Westminster (CA); Alan CARR, Las Vegas, NV (US)

(73) Assignee: Dapper Labs Inc., Vancouver, BC (CA)

(21) Appl. No.: 17/382,455

(22) Filed: Jul. 22, 2021

(51) Int. Cl. G06Q 30/00; G06Q 20/36

(52) U.S. Cl. CPC G06Q 30/0185; G06Q 20/36

(57) ABSTRACT

A system and method for managing access to offerings of online digital collectibles. Access may managed according to various eligibility criteria related to a user. The eligibility criteria may relate to aspects of the user's participation, involvement, holdings, or actions in the system. To determine whether a user is eligible for a collectible offering, the system may determine eligibility criteria associated with the offering and obtain from a user's account the information necessary to determine if the user meets the eligibility criteria. The criteria may include a measurement of the digital collectibles currently in the user's account, prior purchase activity by the user, and/or other user-related information tracked by the system.

### FIELD OF THE INVENTION

The field of the invention relates to managing access to online digital collectibles (e.g., based on various eligibility criteria related to the user's collection of digital collectibles and/or prior actions relating to the digital collectibles).

### BACKGROUND OF THE INVENTION

Physical collectibles, such as baseball cards, are known. Recently, digital collectibles have also been developed. The field of digital collectibles has rapidly grown. Many forms of digital collectibles are known. The subject matter of digital collectibles varies widely. One popular category of digital collectibles is sports collectibles. One popular form of sports collectibles relates to digital collectibles based on sports highlights. With some sports highlights collectibles, the sports highlights collectibles are distributed via the internet as packs. Each pack may include multiple sports highlights collectibles.

For various reasons there may exist a limited number of sports highlights collectibles at any given time. Due to the popularity of digital collectibles, this can create a situation where there are many more people who wish to purchase new packs then there are packs available. This can lead to various problems including significant load on the servers that are used to process the requests for and delivery of the digital collectibles.

These technical problems and other issues can exist with internet-based services that provide digital collectibles.

### BRIEF SUMMARY OF THE INVENTION

According to an aspect of the invention, a system and method for managing access to offerings of online digital collectibles is provided. In various embodiments, access may be managed according to various eligibility criteria related to a user. The eligibility criteria may relate to aspects of the user's participation, involvement, holdings, or actions in the system.

According to some embodiments, a digital collectible system may be hosted via a web site or other Internet-based functionality, such as an app or other specific ecosystem. The website may enable users to register with the website and acquire digital collectibles or packs of digital collectibles. The website may store the digital collectibles and/or a record of the user's transaction history relating to the digital collectibles in association with a user account on a storage device associated with the website. The website may include a secondary marketplace that may enable users to buy and sell collectibles and/or unopened packs from and to other users.

According to some embodiments, when a new offering of a digital collectible is made available by the digital collectible system through the website (individually or as packs of collectibles), eligibility criteria may be disclosed and programmed in association with the offering. The system will determine whether particular users meet the eligibility criteria before allowing the user to acquire the offering. By way of example, the eligibility criteria may include criteria relating to the status of the user's current collection of digital collectibles, the user's transaction history in the system, and/or other user-related eligibility criteria. Eligibility criteria may be applied to determine what users to send an offering to, to confirm that a particular user may acquire the offering, or a combination of these analyses.

According to some embodiments, to determine whether a user is eligible for a collectible offering, the system may determine the eligibility criteria programmed in association with the offering and obtain from the user's account the information necessary to determine if the user meets the eligibility criteria. For example, the server may identify the current digital collectibles in the user's account, prior purchase activity by the user, and/or other user-related information tracked by the system. Based on a comparison of the programmed eligibility criteria and the user-specific digital collectibles information, the system may make a determination of whether the user meets the eligibility criteria for the offered pack. If the user is determined to meet the eligibility criteria, the system may generate and send an offer to the user, or confirm that a user may acquire the offering by generating an indication of eligibility and authorization to proceed. If the user is determined not to meet the eligibility standards, the system may not send an offer to the user, may generate an indication of non-eligibility in response to a user's attempted acquisition of the offering, or may provide an indication of non-eligibility and instructions on actions the user may take to meet the eligibility criteria for the offering.

According to some embodiments, the system may determine information about a user's collection of collectibles at least in part via a digital wallet associated with the user account.

According to some embodiments, individual digital collectibles may include at least one digital media file and associated data or other content. A digital media file may relate to a visual representation of an event during an entertainment experience, such as a video highlight or related images, and the data may be data associated with the event, experience, and/or the digital media file. For example, the digital collectibles may relate to video highlights from a sporting event (e.g., professional collegiate or amateur sports). However, the invention may be applied to other types of digital collectibles as well.

According to some embodiments, each digital collectible may have a predetermined number of instances that will be distributed. The number of instances of each may determine a rarity level or tier for that digital collectible. Different numbers of rarity levels or tiers may be used.

According to some embodiments, collectibles and packs may be offered in series, or categorizations indicating that the collectible or pack is part of a larger collection of temporal events. For example, a series might relate to a particular professional sports season or other series.

According to some embodiments, collectibles and packs may be part of sets, or categorizations indicating that the collectible or pack is part of a larger collection of a particular theme, with a common characteristic, or part of an arbitrary grouping set by the system for a particular reason. For example, a set could be a collection of spectacular plays occurring during a given week or month, or from a particular series or other sets.

According to some embodiments, eligibility criteria for an offering may be determined by a system administrator and programmed in connection with the offering. The eligibility criteria may be stored by the system in connection with the offering. Various eligibility criteria may be used, some examples of which follow. The invention is not limited to these examples.

According to some embodiments, the system administrator may create and store an eligibility criteria for the offering based on one or more portions of user-specific data, such as how many and what type of collectibles a user owns, a user's reward point balance, a user's monetary balance, whether the user has completed particular sets, or other applicable user-specific data. In other embodiments, formulas using multiple criteria may be used, including formulas that weight some criterion more than others.

According to some embodiments, the system administrator may create and store an eligibility criteria based on a collector score. The collector score enables the system administrator to set and store in association with an offering a minimum target score necessary for the user to qualify for eligibility to acquire the offering. The collector score can include various components to enable the user to qualify in a number of ways based on a user's collection of digital collectibles and/or actions in the system.

According to some embodiments, a user's collector score may be based on the digital collectibles the user owns at the time the score is to be calculated. Each digital collectible may be assigned a point value based on various attributes of the digital collectible. The attributes may include, e.g., a collectible's rarity, tier, series, set, and/or other attributes.

According to some embodiments, the point value for a digital collectible may also be based on how the user acquired the digital collectible. For example, this may include whether the user obtained the digital collectible by purchase of a pack or other offering from the service, by purchase of the digital collectible via the secondary market, by obtaining the digital collectible as a challenge reward, by obtaining the digital collectible through a promotion and/or other methods of acquisition.

According to some embodiments, additional bonuses added to the collector score may also be used. For example, bonuses may be awarded for a user holding a particular set of digital collectibles, a user's status in the system, such as according to a reward point balance, or any other user-specific data.

According to some embodiments, the user's collector score may be calculated by a formula using one or more of the above attributes, which may be weighted differently to enable a weighted scoring system.

To provide the above aspects, according to some embodiments, there is provided a system and method for creating, managing, trading, and displaying a limited edition, serialized 3D digital collectible. A 3D digital collectible may be an instance of a limited edition batch of instances of the same 3D digital collectible. The limited edition batch may include a predetermined number of instances of the 3D digital collectible in the batch, where the predetermined number may be guaranteed not to increase. Each instance of the limited edition collectible in the batch may be marked at creation with a unique serial number. The serial number may be a unique number between 1-n, where n is the predetermined number of instances of the 3D digital collectibles in the batch. Each instance of the 3D digital collectible in the batch may be displayed with an indication of the unique serial number for that instance of the 3D digital collectible and/or an indication of the number of collectibles in the batch. For example, the first instance of the 3D digital collectible in the batch may be associated with an indicator of 1 of n. The second instance of the 3D digital collectible in the batch may be associated with an indicator of 2 of n and so on for each of the n instances of the 3D digital collectibles in the batch. The predetermined number of instances may be stored for each 3D digital collectible as at least a part of rarity data that may be stored. As detailed below, the number of instances may be used in connection with a rarity classification of the 3D collectible.

According to some embodiments, the platform may create different batches of different limited edition 3D digital collectibles. Each of the batches may have a predetermined number of instances of collectibles in the batch. Based on a set of rules stored in the system (e.g., by a system administrator), each of the batches may be classified according to a rarity type based on the number of instances of the 3D digital collectible in the batch. For example, there may be various classification descriptors (e.g., common, rare, legendary and/or other classification descriptors). By way of example, a common classification may correspond to batches that have more than a first number of instances (e.g., over 1000), a rare classification may correspond to batches that have less than the first number of instances but more than a second number of instances, and a legendary classification may correspond to batches that have less than the second number of instances. Any number of classifications can be used. The number of instances of a collectible in a batch that defines the classification can vary. This information may be stored for each 3D digital collectible as rarity data.

According to some embodiments, a 3D digital collectible may be displayed with a graphical visual indicator that corresponds to a rarity classification type or otherwise indicates rarity data.

According to some embodiments, different 3D digital collectibles from different batches may bundled into packs. Each pack may comprise only 3D digital collectibles of a single rarity type classification. In other cases, a pack may include 3D digital collectibles of a more than one rarity type classification. The pack configurations may be determined by a system administrator.

According to some embodiments, ownership of a limited edition 3D digital collectible may be represented by a non-fungible token (NFT), for example an ERC-721 or other type of NFT. Each instance of the 3D digital collectibles in a batch may be represented by a separate NFT. Each NFT may be minted with metadata that includes the instance of the 3D digital collectible (e.g., the unique serial number) in the batch and the total number of instances of the 3D digital collectible in the batch. When the NFT is minted and/or assigned to a digital wallet of a purchaser of the collectible, it may include metadata that includes the instance of the 3D digital collectible (e.g., the unique serial number). Recording this information on a blockchain (which is an immutable ledger) provides a technological approach to enabling a collector to confirm whether the actual number of instances of the 3D digital collectible in the batch does not exceed the guaranteed number of instances of the 3D digital collectible that the issuer indicates the batch will not exceed. This technological approach facilitates the guaranteed scarcity, confirms ownership of each instance and establishes the provenance of the instance of each collectible.

According to another aspect of the invention, the 3D digital collectible may include at least one digital media file (e.g., a video file), or multiple digital media files, representing an event (e.g., a sports play or other events as detailed below) rendered on a representation of at least a first of the n surfaces of the n-sided 3D shape, data or other content relating to the event rendered on at least a second surface thereof, and other content on one or more other surfaces of the n-sided 3D shape. Each surface may include a combination of digital media files, data and/or other content. The digital media file may be video clip of the event or a portion thereof that can be played automatically via a media player associated with the display. A digital media file may relate to a visual representation of an event during an entertainment experience, such as a video highlight or related images, and the data may be data associated with the event, experience, and/or the digital media file. The digital media files, data and/or other content may be stored in a system memory associated with the server.

According to another aspect of the invention, there is provided a platform for creating, managing, trading, and displaying 3D digital collectibles. The platform may include a computer server including a processor programmed with computer instructions including at least an administration module, a display generator, and a media player. The platform may also include an associated computer memory that stores a data structure comprising media files, associated data, and other content and an association therebetween, along with rules that define what digital media files, data and/or other content is to be displayed on the 3D digital collectible, including each of the surfaces thereof, what digital media files, data and/or other content is to be displayed on the overlay display element, what indications are to be displayed on the surrounding structure, and metadata relating to events and other information.

According to some embodiments, the data structure stored in memory includes an association of the digital media files, data and/or other content that is to be displayed on a first surface of the n-sided 3D shape and the digital media files, data and/or other content that is to be displayed on the overlay display portion (e.g., when a first surface of the n-sided 3D shape is forward facing or at least partially forward facing). The data structure may include an association of the digital media files, data and/or other content that is to be displayed on the overlay display element when the other surfaces of the n-sided 3D shape are forward facing or at least partially forward facing.

According to some embodiments, the event may include a highlight from any type or category of experience, including without limitation a sporting match. In the context of a sporting match, the highlight may include a video clip of the highlight, such as a player dunking a basketball or any other event from any type of sports match. The events are not limited to sports. The event may be video or other form of capture of any of a number of other experiences, including without limitation, sports, athletic events, esports and other competitions or other participatory experiences, artistic or theatrical productions (such as a show, play, concert, opera or other production), an awards show, a television show, movie, game, streaming media, social media or other entertainment experience, an information experience such as a speech, news report, political debate or other information experience other categories of events or experiences. The platform described is intended to cover a wide variety of event types from a wide variety of experiences.

According to some embodiments, various types of media files, data and other content may be associated and stored with the event. A first type of data may include event data that describes the event itself. In the context of a sporting match, the event data may include the player, the type of action (e.g., a dunk, block, steal or other action), the date of the event, and other event data. A second type of data may include actor data relating to the person captured in the event. For example, in the context of a sporting match, the actor data may include the player's age, hometown, college, statistics and other actor-related data. A third type of data may include context data that describes additional information about the context of the event. For example, in connection with a sporting match, the context data may include the teams that were playing when the event was captured, where the game was being played, the score of the game, and other context data). The media file, the various associated types of data and other items associated with an event may be collectively referred to as content. In some embodiments, the content is stored in memory in associated with the event (or an event identifier) and at least some of the content may be selectively displayed on the 3D visual display element in accordance with a set of rules and/or metadata.

According to some embodiments, the data associated with an event may also include metadata. Metadata may include information specified in connection with the creation of the digital collectible that specifies the content to be displayed and the manner in which the content should be displayed, such as what content should be displayed, where the content should be displayed (e.g., which surface), and how the data should be displayed. Other metadata may include information associated with the classification of the digital collectible or other information relating to the collectible, such as rarity data.

According to some embodiments, the process of creating a 3D digital collectible may include an administrative user interface for specifying the rules for one or more 3D digital collectibles, including the n-sided 3D shape, any overlay display elements, any surrounding structure display elements, any visual indicators, the a content to be displayed on the 3D digital collectible and the surfaces to which the data is to be assigned, including surfaces of the n-sided 3D shape and overlay display element(s) and other rules and input described herein to define a 3D digital collectible, its various display options and attributes of thereof.

The above stated aspects, as well as other aspects, features and advantages of the invention will become clear to those skilled in the art upon review of the following description. It should be understood that the description and specific examples, while describing several exemplary embodiments, are intended for purposes of illustration only and are not intended to limit the scope of the disclosure.

### BRIEF DESCRIPTION OF THE DRAWINGS

The above and/or other aspects of the invention will be more apparent by describing in detail exemplary embodiments of the invention with reference to the accompanying drawings, in which:

FIGS. 1a-1f shows a 3D digital collectible according to some embodiments of the invention;

FIGS. 2a-2q show aspects of a 3D digital collectible according to some embodiments of the invention;

FIGS. 3a and 3b show a digital media playing applications according to some embodiments of the invention;

FIG. 4 shows aspects of a 3D digital collectible management system according to some embodiments of the invention;

FIG. 5 shows aspects of a 3D digital collectible creation process according to some embodiments of the invention;

FIGS. 6a-6d show aspects of user controllable viewing tools according to some embodiments of the invention;

FIG. 7 shows aspects of a pack of 3D digital collectibles according to some embodiments of the invention;

FIGS. 8a-8c show aspects of the display of contents of packs of 3D digital collectibles according to some embodiments of the invention;

FIG. 9 shows aspects of a challenge according to some embodiments of the invention; and

FIG. 10 shows aspects of a method for using eligibility criteria according to some embodiments of the invention.

### DETAILED DESCRIPTION OF THE INVENTION

Exemplary embodiments of the invention will now be described below by reference to the attached Figures. The described exemplary embodiments are intended to assist the understanding of the invention and are not intended to limit the scope of the invention in any way. Like reference numerals refer to like elements throughout. The examples are provided in connection with a sports event by way of example only. The platform may be used with other events including the other types of events referenced herein and other types of events.

The 3D Digital Collectible

Aspects of various types of events may include important portions which can be captured (as digital media files or other forms of capture). Such digital media files may include videos, images, sounds, and or other forms of capture that record a particular event during an experience. For example, in relation to sports, an event can be a particular play, such as a dunk in a basketball game, a goal in a soccer match, or a catch in baseball. In such examples, the event may be captured as a video, audio and/or other form of highlight, including from one or more perspective views, as a digital media file or files. The event can be of different durations appropriate to memorialize the event. An event may be part of a live-action experience, such as a sporting match or play, or a scripted or pre-recorded experience, such as a movie.

In an exemplary embodiment, a 3D digital collectible may be defined, generated, and rendered. The 3D digital collectible may include a digital media file (e.g., a video highlight clip) or multiple digital media files (e.g., different perspectives of the same event or a series of files before, during and/or after the event) representing an event, along with data relating to the event and/or collectible, including event, actor, context, scarcity, series, and set data, along with metadata, as explained below. An event may include all or any identifiable portion of an experience.

The 3D digital collectible may be a virtual, three dimensional n-sided structure (where n is preferably greater than 3), where the n-surfaces may be configured to form an n-sided 3D shape, such as a cube, pyramid, octagon, or other 3D shape. One or more of the surfaces of the n-sided shape may display one or more digital media files, or portions of such digital media files, and/or one or more portions of data (or other content) in a defined relationship stored in memory such that a particular surface may display a digital media file or files, or portions thereof, a portion or portions of data, other content or combinations thereof.

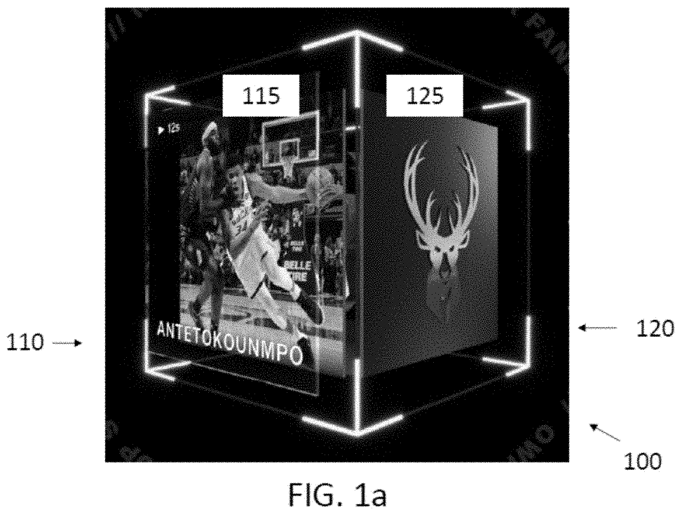

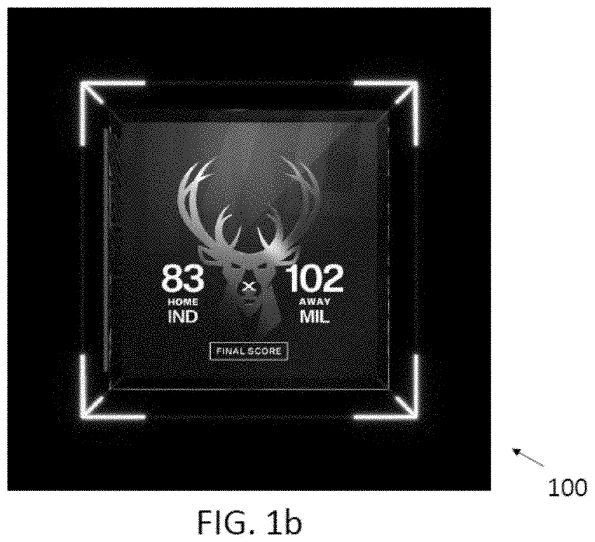

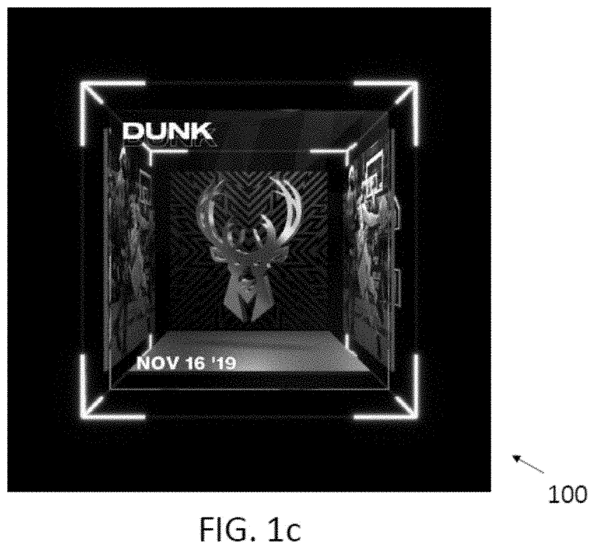

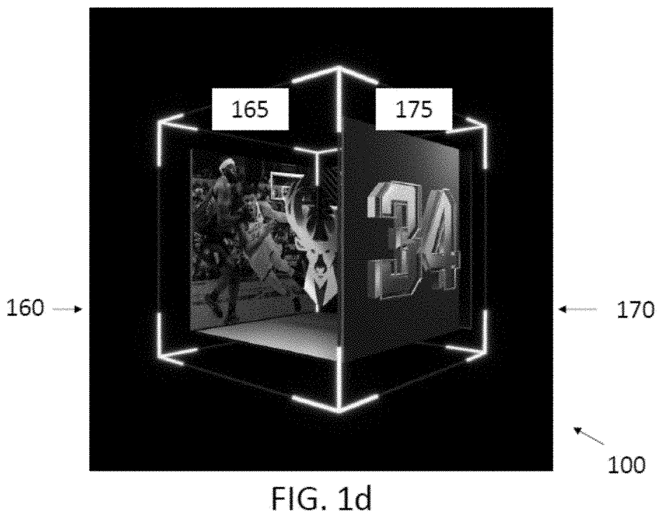

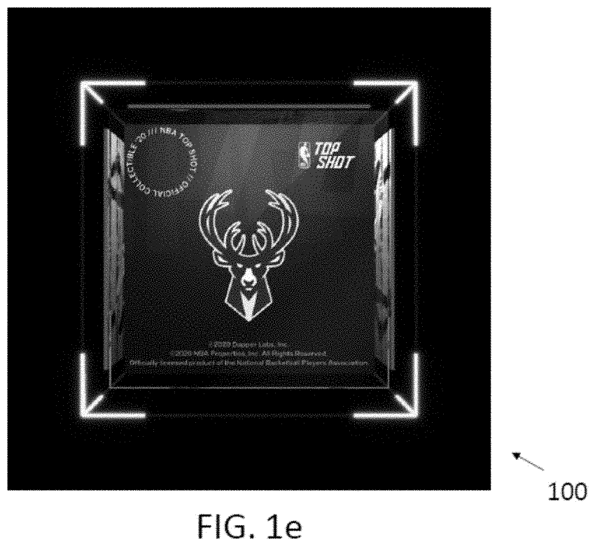

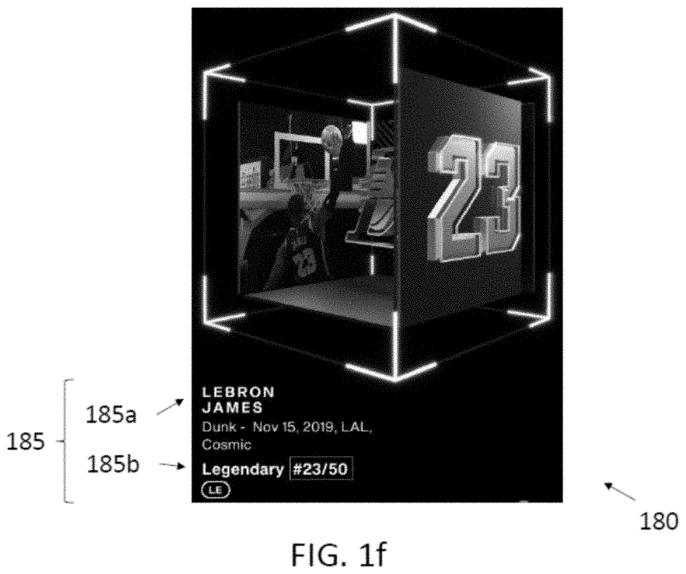

In the exemplary embodiment shown in FIG. 1a, a 3D digital collectible 100 includes a 6-sided 3D cube. In the perspective view of FIG. 1a, first surface 110 and second surface 120 of the cube are visible. First surface 110 has a digital media file 115, in this case a video clip. Second surface 120 has data 125, in this case the logo of the team of which a player in digital media file 115 is a member. Additionally, 3D digital collectible 100 includes a cube shaped framework arranged around the 3D cube, along with an overlay display element above first surface 110, both of which are discussed in more detail below. FIGS. 1B-1e show further views of 3D digital collectible 100. In FIG. 1B, another surface of 3D cube is shown. This surface includes data, in this case a team logo and score related to the event to which the 3D collectible is related. In FIG. 1c, another surface of 3D cube is shown. This surface also includes data, in this case a team logo and a date and description of the event to which the 3D digital collectible is related. In FIG. 1d, another perspective view of 3D digital collectible 100 is shown. In this view, a surface 165 with different representation of a team logo is provided, such that it appears within collectible 100, along with a surface 175 with a number of the player shown in the video clip on surface 110. In this embodiment, the rear of surface 110 showing digital media file 115 may be seen through 3D digital collectible 100. In FIG. 1e, another surface of the 3D cube with a team logo and copyright and system information is shown.

In various embodiments, the 3D digital collectible may be statically displayed in its virtual environment (e.g. on a computer display screen), or may be dynamically displayed, such that it is rotatable to display one or more of the surfaces and the associated content (e.g., a digital media file and/or data) assigned to that surface. Such dynamic display may be way of interactions with a user, in response to a predefined movement or movements (e.g., via a script or other computer code), or combinations thereof.

The digital media file may be any type of media, including still images, video, audio, and/or other media, or combinations of such media. Digital media files may include a single view, audio track, or other recording, or composites of multiple views, audio tracks, or other recordings, such as a composite video showing different perspectives of the event, such as different camera views of a sports play or other event. The digital media files may also include multiple views, audio tracks, or other recordings of the event from different perspectives, times, or durations that may be played sequentially and/or in other order. Such sequential play can be implemented by user interactions with a list of the multiple views, audio tracks, or other recordings, by accessing the multiple views, audio tracks, or other recordings in accordance with a script, or by stitching together the multiple views, audio tracks, or other recordings into a single digital media file. In this regard the composite or sequential digital media files may include different types of files (e.g., they may include one or more of a video file, audio file, or other recording). Portions of a single digital media file may also be identified, separated, and used as individual digital media files in the manner described herein (e.g., a digital media file may be sequentially divided with different portions considered as different digital media files). For example, a single digital media file may be sequentially divided and provided on different surfaces of the 3D digital collectible.

The data relating to the event may include event data that describes the event itself. Using a sporting match as an example, event data may include such information as the player's name, the type of play (such as a dunk, block, or steal), the date and/or time of the event, and other event data. A second type of data may include actor data relating to the person captured in the event. Again using a sporting match as an example, actor data may include such information as the player's statistics, measurements, position, age, experience, hometown, college, draft selection, or other actor (or actors) data. A third type of data may include context data that describes additional information about the context of the event. Again using a sporting match as an example, context data may include the teams that are playing, the location of the game, the score of the game, the sports league, the sports season, and context data. The digital media file and any related data and/or other content may be collectively referred to as content.

Further exemplary embodiments of context data include information related to an entertainment experience from which the event is drawn, situational information related to the entertainment experience, the subject of the experience, and/or information related to the digital media file. For example, context data related to a sporting match may include the number of teams, the box score, game statistics, seasonal averages for the player, media about the game, and other context data. In the sporting match example, the context data may relate to one or more players or teams that are represented in a digital media file.

The various forms of data may be associated with a digital media file in any known manner, such as by tags, attributes, metadata, pointers and/or other associations. Data may be stored in a data structure in one or more databases. The data structures may link an event with media files, data, content and metadata. The event and/or digital media file can be searched based on information associated with the event or the digital media file.

Data may also include metadata. Metadata may include information specified in connection with the creation (or, in certain instances, modification) of the 3D digital collectible that specifies attributes of the digital collectible, or data describing the placement of the 3D digital collectible in a series, set, collection, as part of a challenge, or other like aspects, as described in detail below. The attributes may include the configuration of the digital collectible (e.g. the number of sides) the manner in which content should be displayed, such as what content should be displayed, where the content should be displayed (e.g., on which surface of the n-shape), and how the content should be displayed, including in relation to other content. Other attributes of the digital collectible may be used.

The digital media file and data may also be created based on another digital media file or data. For example, a digital media file including a graphic and/or sound may be generated based on a digital media file including a video. As such, 3D digital collectibles can include one or more related digital media files and data. Further features of a 3D digital collectible are described in more detail in U.S. application Ser. No. 17/229,455 titled “System And Method For Creating, Managing, And Displaying 3D Digital Collectibles” filed Apr. 13, 2021, hereby incorporated by reference in its entirety.

Rarity

Metadata may also include information associated with the uniqueness, rarity, or scarcity of the digital collectible in the system. For example, a 3D digital collectible may be a one of a kind instance of an event, or there may be a predetermined number of instances of the event (e.g., copies of the 3D digital collectible). Other methods for determining the number of instances may be used. In any case, the digital collectible may be identified by a serial number or other unique value that uniquely identifies a particular 3D digital collectible in the system, along with a unique identifier for the instance (e.g., 1 of 1 or 1 of 10, etc.) as necessary. The unique identifier may be stored as rarity data by the system, as discussed below, and may be displayed on surfaces or overlay display elements of the 3D digital collectible, or as information adjacent the 3D digital collectible when it is viewed.

In some embodiments, as shown in FIG. 1f, a 3D digital collectible 180 may be displayed with a tag 185 that displays event and context data 185a and rarity data 185b. For example, 3D digital collectible 180 may be an instance of a limited edition batch of the same 3D digital collectible, as indicated by “LE” in displayed rarity data 185b. A limited edition batch may include a predetermined number of instances of the 3D digital collectible in the batch, where the predetermined number is guaranteed not to rise, as indicated by the “50” in displayed rarity data 185b. Each instance of the limited edition collectible in the batch may be marked at creation with a unique serial number. The serial number may be a unique number between 1-n, where n is the predetermined number of instances of the 3D digital collectibles in the batch, as indicated by the “23” in displayed rarity data 185b. Each instance of the 3D digital collectible in the batch may be displayed with an indication of the unique serial number for that instance of the 3D digital collectible and/or an indication of the number of collectibles in the batch. For example, the first instance of the 3D digital collectible in the batch may be associated with an indicator of 1 of n. The second instance of the 3D digital collectible in the batch may be associated with an indicator of 2 of n and so on for each of the n instances of the 3D digital collectibles in the batch. In FIG. 1f, this is shown by the “23/50” in displayed rarity data 185b. All of this information may be stored for each 3D digital collectible as rarity data. Rarity information may also be displayed on any surface or overlay display element of the 3D digital collectible instead of, or in addition to, a tag.

According to some embodiments, a user may own one or more instances of the 3D digital collectible in the batch. When a user owns more than one instance (e.g., both instance 1/50 and instance 23/50), this is called a “stack.” In various embodiments, a user may own any number of instances of the 3D digital collectible, or may be limited to a certain number of the total instances.

According to some embodiments, the platform may create different batches of different predetermined numbers of different limited edition 3D digital collectibles. For example, one batch of a limited edition 3D digital collectible may have 50 copies, such as is shown in FIG. 1f, while another batch of a different 3D digital collectible may have 1000 copies. Based on a set of rules stored in the system (e.g., by a system administrator), such different batches with different predetermined numbers of the 3D digital collectible may be classified according to a rarity type based on the number of instances of the 3D digital collectible in the batch. For example, there may be various classification descriptors (e.g., common, rare, legendary and/or other classification descriptors). These descriptors may also be called “tiers.” By way of example, a common classification (or tier) may correspond to batches that have more than a first number of instances (e.g., over 1000), a rare classification (or tier) may correspond to batches that have less than the first number of instances but more than a second number of instances, and a legendary classification (or tier) may correspond to batches that have less than the second number of instances. Any number of classifications, categorizations, or tiers can be used. The number of instances of a collectible in a batch that defines the classification (or tier) can vary. This information may be stored for each 3D digital collectible as rarity data. Rarity values, categories, tiers, and related parameters can be set for an individual 3D digital collectible as part of the initial creation process in defining the collectible. Rarity values, categories, tiers, and parameters may be selected by a creator of the 3D digital collectible, or may be determined automatically based on the selected digital media files and/or other data.

A rarity category for a particular 3D digital collectible may also be displayed on surfaces or overlay display elements of the 3D digital collectible, or as information adjacent the 3D digital collectible when it is viewed. For example, FIG. if shows 3D digital collectible 180 with tag 185 showing rarity information 185b with the rarity category “Legendary” displayed. Any categorical information may be displayed in this manner. Rarity category information may also be displayed on any surface or overlay display element of the 3D digital collectible instead of, or in addition to, a tag. All of this information may be stored for each 3D digital collectible as rarity data.

Alternatively or additionally, other displayed features of the 3D digital collectible may provide a visual indication of the rarity category of the collectible, such as through colors, shading, material, textures, lighting and the like. For example, the cube-shaped surrounding structure shown in FIG. if (discussed in more detail below) may include highlighted corners of a particular color that provide a visual indication that 3D digital collectible is a “legendary” 3D digital collectible.

According to some embodiments, the system may include a set of rules that correlate to a special significance either across batches of 3D digital collectibles or within a particular batch. For example, the first instance in a batch (e.g., the #1 of n instances in the batch) may be deemed to have a special significance. As another example, if the collectible relates to a sports event depicting a highlight of an activity by a particular player, a rule may correlate a special significance within that particular batch for the instance of the batch that has a serial number corresponding to a number of significance to the player (e.g., the player's jersey number). For example, in FIG. 1f, the event is a dunk by Lebron James, whose jersey number is 23. The serial number of the 3D digital collectible shown in FIG. if is #23/50. Thus, it may have special significance.

According to some embodiments, an instance of a 3D digital collectible that correlates to a special significance (e.g., based on a stored set of rules) may be displayed with a graphical visual indicator that signifies that instance has a special significance or a graphical visual indicator that signifies the specific special significance.

According to some embodiments, ownership of a limited edition 3D digital collectible may be represented by a non-fungible token (NFT), for example an ERC-721 or other type of NFT. Each instance of the 3D digital collectibles in a batch may be represented by a separate NFT. Each NFT may be minted with metadata that includes the instance of the 3D digital collectible (e.g., the unique serial number) in the batch and the total number of instances of the 3D digital collectible in the batch. When the NFT is minted and/or assigned to a digital wallet of a purchaser of the collectible, it may include metadata that includes the instance of the 3D digital collectible (e.g., the unique serial number). Recording this information on a blockchain (which is an immutable ledger) provides a technological approach to enabling a collector to confirm whether the actual number of instances of the 3D digital collectible in the batch does not exceed the guaranteed number of instances of the 3D digital collectible that the issuer indicates the batch will not exceed. This technological approach facilitates the guaranteed scarcity, confirms ownership of each instance and establishes the provenance of the instance of each collectible.

Series

Metadata may also include information indicating a series of which the digital collectible is a part. A series can be any applicable categorization of the collectible that signifies it is part of a larger collection of temporal events. In one exemplary embodiment, if a 3D digital collectible relates to a sporting event, the series may be representative of the relevant sports league's season. For example, the collectible shown in FIGS. 1a-1e is for an event that occurred during an NBA game on Nov. 16, 2019, and is thus part of the NBA's 2019-2020 season. It can therefore be assigned to a series representative of the 2019-2020 season.

A series can also relate to other time-based measurables, such as a particular playoff series (e.g., a particular best of seven round of games for a particular sports league) or an in-season series (e.g., a particular number of games played in a row between teams during a season, such as in baseball). Other criteria for creating a series can be used. Series can also be used with non-sports collectibles, such as a particular campaign season for a political collectible, a television season for a television-related collectible, a particular Oscar season for a movie-related collectible, and the like. A series can be identified by its description (e.g., 2019-2020 NBA season, 2020 playoffs) or another descriptor, such as series 1, series 2, etc., or other labels that are understood in context.

Series information may be displayed on the collectible in the same manner as any other data discussed herein. For example, series information may be displayed as part of, or adjacent to, tag 185 in FIG. 1f, or as part of the information shown on the collectible face shown in FIG. 1e. Other visual indications of a series may also be used in the same manner discussed above with respect to a rarity indication, including both by textual indications and through colors, shading, material, textures, lighting and the like.

In some embodiments, a collectible will belong to a single series. In other embodiments, a collectible may belong to multiple series. For example, a particular NBA-related collectible may belong to both of a 2019-2020 seasons series and a particular playoff series.

In addition to individual collectibles, series information may also be used to categorize packs, as discussed below. For example, a pack labelled “2019-2020 NBA Season” will only contain collectibles from the 2019-2020 NBA Season.

Sets

Metadata may also include information indicating a set to which the digital collectible belongs. A set can be any applicable categorization of the collectible that signifies it is part of a larger collection of a particular theme, with a common characteristic, or part of an arbitrary grouping set by the system for a particular reason. In one exemplary embodiment, if a 3D digital collectible relates to a sporting event, a set may be made up of a group of similar events in a particular time span. For example, a set could be a collection of spectacular plays occurring during a given week or month, or from a particular series. Alternatively, a set could be a particular play that occurred during a set time frame (e.g., goals on free kicks during soccer matches in a particular season). In another example, if the event is a dunk during a basketball game, the set might be the five players on the court for the dunking player's team, or the players directly involved in the play on both teams. In a non-sports context, a set could be made up of a number of speech snippets from a politician on a particular issue, a set of similar scenes from movies, a set of appearances by a particular actor on television shows, and the like. Sets can also be based on groupings of people. For example, sets can be made up of all the players on a particular team on a particular season or that are part of a particular series. A set could also be made up of all the players on a particular team over multiple seasons or series. In other embodiments, a set could be all the players from a particular all-star game, all the actors from a particular movie, all the candidates from a particular election, all the winners of major tennis or golf tournaments from a season or series, or the like. A set may also be any number of collectibles defined by the system or a system manager to be part of a challenge set, as described below. Any of the above examples, or similar sets, may be used as challenge sets.

Series and set data may be used individually or together to identify and categorize collectibles and/or packs, as discussed below. When used together, sets are hierarchically below series. In some embodiments, individual collectibles will only be part of one series and one set. For example, an individual collectible may be part of the 2020-2021 NHL season and a Detroit Red Wings set.

User Account

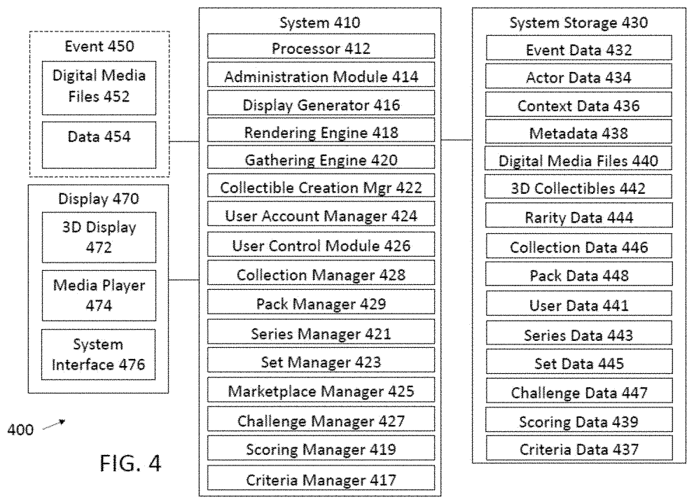

The storage, ownership, categorization, and display of 3D digital collectibles is managed by a system described in more detail below with respect to FIG. 4. The system includes provisions for users to create and manage a user account in the system that allows users to own, categorize, and display the 3D digital collectibles in the manner discussed herein. User accounts may be created by a user during an initial log-in process by creating a user name and password, and may include personal information about the user, such as a user's name, address, email address, phone number, payment information, etc. The user account may also be related to a unique identifier in the system for the user, either created by the user (e.g., by a unique username) or by the system (e.g., an assigned unique alphanumeric value). Any of the foregoing information may be stored in a database related to the user account, or a digital wallet.

When acquired by a user, 3D digital collectibles are associated with the user account by the system. Thus, when a user logs in to the system, he will be able to view each 3D digital collectible he owns, or which are otherwise associated with his account. In some embodiments, such information may also be used to publicly display a user's collectibles to other users. User accounts may also include provisions to track the number of collectibles of a particular set or series owned by the user. Particularized user-defined collections of collectibles may also be associated with the user account, as discussed below. This information can also be stored in the digital wallet.

Based on the information maintained in the user account (or digital wallet), the 3D digital collectible system may query the user account, such as by its unique identifier, to determine information about the 3D digital collectibles owned by, or otherwise associated with, the user. For example, the system may determine the number of collectibles owned by the user, along with the number of collectibles in any of the categories discussed herein. For example, the system may determine the number of legendary collectibles, the number of collectibles of a particular series, and/or the number of collectibles of a particular set owned by the user.

The user account may also be associated with a system monetary balance or reward point balance. The monetary balance may represent a value of real-world or digital currency in the system that the user may use, add to, or withdraw in connection with buying and selling collectibles. For example, the monetary balance may be adjusted upward by proceeds from the user selling collectibles or by the user transferring funds into the system, or may be adjusted downward by the user buying collectibles or withdrawing funds from the system. The monetary balance may be displayed to a user in terms of a real-world or digital currency (e.g., U.S. dollars) or in terms of a system-based currency (e.g., system dollars) that may or may not be representative of real-world currency.

The user account may also store other information related to the monetary value of acquisitions or sales of collectibles. For example, the user account may track the total dollar amount a user has spent on acquiring collectibles in a time frame, the total dollar amount received by the user from selling collectibles, and/or any data derived therefrom, such as averages or differentials. The user account may also store information related to the dates and times of a user's acquisitions or sales, the location of the user during the acquisition or sales, etc.

A reward point balance may represent a value of reward points obtained by the user for participating in the system. Reward points may be obtained for performing certain actions, tasks, or challenges. For example, reward points may be obtained by a user in response to such actions as adding funds to a monetary balance, buying a collectible, or maintaining a user account for a certain time period. Reward points may also be obtained by a user by completing certain tasks or challenges defined by the system, such as those discussed below.

Additionally, reward points may be used to determine a user's status in the system. For example, a user may be successively classified as a level 1 user, level 2 user, level 3 user, etc. depending on the user's increasing reward point balance. Various contextually appropriate classification schemes can be used. For example, in the context of an NBA-related collectible system, a user may be successively classified as a “baller,” “rook,” “rising star,” “vet,” and “elite” depending on the user's increasing reward point balance. The user status may be publicly displayed in the system for other users to see. The user status may be determined based on the user's lifetime reward points received, or a current reward point balance in systems where reward points can be used, given, traded, or spent.

User account information may be used to complete purchases, sales, or other actions. User accounts may also be monitored to determine whether a user is eligible to perform a certain action. For example, a user's system monetary balance or reward point balance may be monitored to determine eligibility criteria as discussed below, or for various other administrative functions of the system. For example, a user might need a certain monetary balance or reward point balance to be eligible to acquire a particular pack or collectible when it is offered, as discussed below.

Challenges

The system managing the 3D digital collectibles may set forth particular challenges or tasks for particular users to complete within the system in order to obtain some type of reward. For example, the system may indicate to users that if the user obtains all of the 3D digital collectibles in a particular challenge set, such as the sets described above, the user will obtain a particular reward. The reward may include one or more of another collectible, a point allocation that may be added to the user's reward balance, a monetary award added to the user's monetary balance, a particularized opportunity to buy or sell a collectible or collectibles, or another measure of extra value useful to a user in the system.

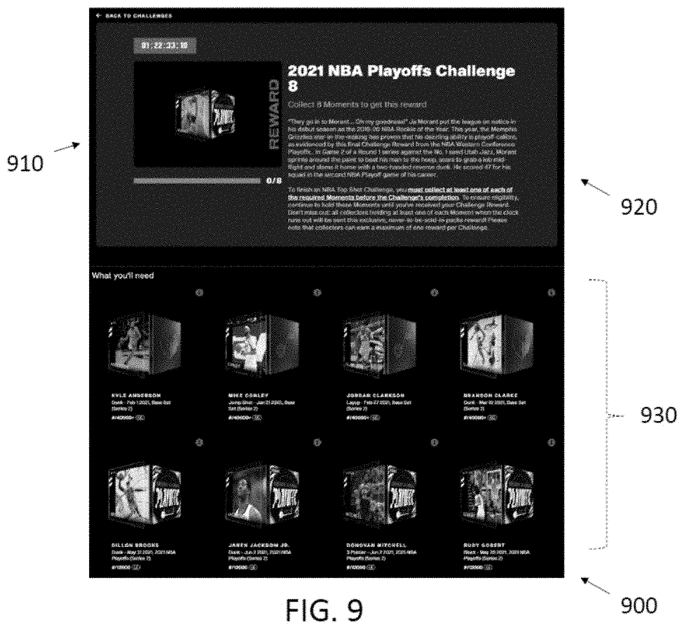

An example of an interface 900, such as a webpage or app screen, identifying a challenge in the system managing the 3D digital collectibles is shown in FIG. 9. Challenge interface 900 may be accessed by a user via a list of challenges provided on another webpage, via a message received by the user, or in any other applicable manner. Interface 900 includes a description 920 of the challenge, which in this example is for the user to collect eight particular 3D digital collectibles and retain them for a set time. Interface 900 also includes a description 910 of the reward, which in this example is a particular collectible. Finally, interface 900 includes placeholders 930 that indicate how many of the identified collectibles have been obtained by the user. If the user completes this challenge, he will obtain the 3D digital collectible identified in 910 as a reward. In this example, the reward collectible identified in 910 is of relatively high value.

The system may manage various challenges to ensure the rewards retain a relatively high value. For example, the system may limit the number of users that can complete the challenge (e.g., only the first 25 to complete the challenge will qualify), limit the time for users to complete the challenge, or limit the number of users to which the challenge is offered (e.g., only users with a particular monetary balance or reward point balance are offered the challenge, or only users holding a particular collectible or a particular set in whole or in part are offered the challenge, or users with a particular challenge score (discussed below) or that meet particular criteria are offered the challenge.

Promotions

The system managing the 3D digital collectibles may also set forth particular promotions from time to time. For example, a promotion may add a multiplier to the funds added to a user's monetary balance during a certain time period, or in return for a user adding funds and purchasing a collectible.

Eligibility Criteria

From time to time, the system may offer a 3D digital collectible, or packs containing 3D digital collectibles as described below, for purchase. For example, a new 3D digital collectible representing a particular play during an NBA game may be offered soon after the play occurs, or at another appropriate time. Packs that include various collectibles may be similarly offered in various time frames.

For some collectibles or packs, the system may impose eligibility criteria whereby only certain users meeting certain criteria may be allowed to acquire the collectible or pack. The eligibility criteria may utilize any information associated with the users to narrow the number of users that may be offered or that may acquire the collectible or pack. For example, the criteria may require a user to have a particular monetary or reward point balance, a particular transaction history (including amounts, times, and frequency), require that a user own a particular collectible(s), a collectible(s) of a particular tier, or a collectible(s) of a particular set, a collector score (discussed below), or combinations of the forgoing or other criteria.

By using eligibility criteria in this manner, the system may identify a subset of users to whom to offer the particular collectible or pack for purchase. By identifying a subset of users in this manner, systemic efficiency is improved and other technical benefits as not all users will be allowed to try to obtain a particular collectible or set at the same time. This avoids overloading the system by simultaneous requests and avoids, for example, attempted transactions that are declined for lack of a required monetary balance, etc. and other technical issues. The use of eligibility criteria also increases systemic efficiency by encouraging users to maintain particular monetary balances, rather than repeatedly converting the balance to real-world currency (e.g., at the time of purchase). This conversion process, particular when occurring adjacent a highly desired collectible or pack offering, can impose significant load on the network and reduces system efficiency.

When eligibility criteria are associated with an offering of collectibles or packs, an offer can be limited to a subset of users. For example, an offer may only appear in the system to users that match the specified criteria. Alternatively, the system may display an offer to all users, but indicate in the offer that only users meeting the particular criteria may acquire the collectible or pack. Further, an offer display may include a button or hyperlink usable by a user to accept the offer, but the button or hyperlink may only be accessible or viewable to users that meet the specified criteria. Still further, on attempting to accept an offer, the system may check to see if the user meets the specified criteria before proceeding to a confirmation step. A combination of these processes may also be used.

Eligibility criteria may be associated with a collectible or pack as of its initial offering by the system only, for a specified number of transactions, or may be permanently associated with the collectible or pack. For example, an eligibility criteria requiring a user to have a certain number of reward points to acquire a new pack or collectible may be applied only on the first sale of the pack or collectible by the system to a user, after which the user may sell the pack or collectible without restriction. In another example, the criteria may be applied to a particular number of sales of the pack or collectible before a user may sell it without restriction. Additionally, criteria may have an independent time limit. For example, an eligibility criteria may be applied to a collectible or pack for the first hour of its offering, after which it may be removed or adjusted if there are any remaining collectibles or packs for sale. The eligibility requirements may be created by an administrator using various user interfaces, including those described herein. The criteria may be stored in a memory of the system. When the offering is launched the system may run a set of rules that identify the user information that needs to be obtained and compared to the eligibility criteria. Based on the results of the comparison, the system determines the eligible users and proceeds with the offering based thereon.

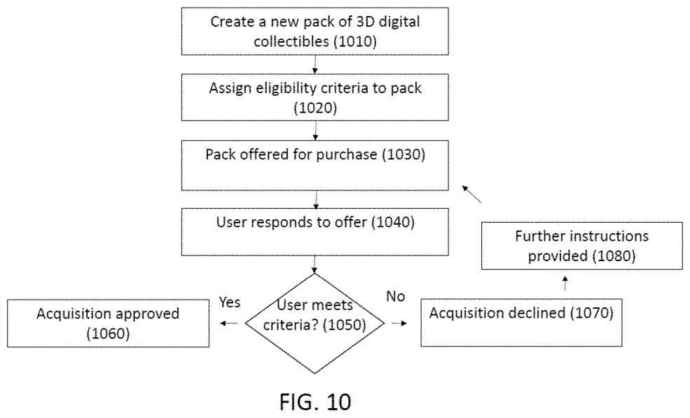

FIG. 10 illustrates an exemplary embodiment of a method of using eligibility criteria. At 1010, a new pack of collectibles is created. Alternatively, this method may be used for individual collectibles as well. At 1020, one or more particular eligibility criteria are assigned to the pack created in 1010. The criteria may be manually entered by a system administrator or another user (via a user interface as described herein or otherwise), or may be automatically assigned by the system based on the content of the pack or collectible and a stored set of eligibility criteria. At 1030, the pack is offered for purchase. In this step, the offer can be provided to all users, or to a subset of users that are determined by the system to already meet, in whole or in part, the criteria. For example, an offer may be made on a system interface, such as a webpage or app page, or in a message delivered to users by email, text, or other means. At 1040, the user responds to the offer, such as by clicking a hyperlink, pressing a button, or through any other appropriate GUI interaction. At 1050, the system compares the specified criteria to user data to determine whether the user meets the criteria. If the criteria are met by the user, the system may generate an indication of eligibility and authorize the user to acquire the pack at 1050 (either immediately of after further acquisition confirmation steps). If the criteria are not met by the user, the acquisition is declined at 1060.

In some embodiments, as discussed above, the pack may be offered only to users that meet, in whole or in part, the criteria at 1030. In the case where the pack is only offered to users that meet all criteria, 1050 may be omitted, and the acquisition may be approved at 1060 immediately upon the user response on 1040. In other embodiments, the criteria check at 1050 may still be performed as a confirmation that the user meets all criteria. In still other embodiments, the check at 1050 can be of a confirmation number or other tracking number included with the offer sent to users that meet all criteria to confirm user identity.

In some embodiments, where the packs are offered to all users at 1030, or where packs are offered to users that meet only some of eligibility criteria for the pack at 1030, the acquisition may be declined at 1050. In such a situation, the system may provide instructions at 1080 that indicate what the user has to do to meet the eligibility criteria for acquiring the offered pack. Further, the system may provide particularized solutions for the user to meet the eligibility requirements. For example, if the eligibility criteria requires a certain monetary balance that the user does not currently meet, the system may suggest adding to the balance to proceed and provide the means to do so. Alternatively, if the criteria requires a certain reward point balance, the system may suggest actions to add to the user's reward point balance and provide the means to do so. Still further, if the criteria requires that a particular type of collectible be owned, the system may provide instructions on how to obtain such a collectible, and provide the means to do so. In any case, should the user perform the suggested actions to meet the eligibility criteria for the offered pack, the user may be returned to the pack offering at 1030 and proceed to respond to the offer at 1040 and acquire the pack at 1060.

As discussed above, moving the criteria determination to different parts of the pack offering process, in whole or in part, allows balancing of the processing load on the system and avoids overloading the system at times of heavy use (e.g., when particularly desirable packs are offered). This improves systemic efficiencies, prevents system failures, and improves system functionality for users.

At 1050 (or at 1030 where packs are selectively offered to particular users), to determine whether a user meets the eligibility criteria, the system may access the user account to compare data therein to the eligibility criteria. For example, the system may determine the user's current monetary balance, reward point balance, the current digital collectibles associated with the user, and data associated with those collectibles, prior transaction activity by the user, and/or other user-related information. Based on a comparison of the eligibility criteria assigned to a pack (or individual collectible) and the user-specific information, the system may determine whether the user meets the eligibility criteria for the offered pack. The comparison itself may be performed in a number of ways. In various embodiments, eligibility criteria will be considered met if a single criterion is met. In other embodiments, multiple criteria, or a percentage of multiple criteria, must be met. In some embodiments using multiple criteria, certain criteria are weighted so as to be more important than other criteria. In some embodiments, the criteria are represented by a mathematical formula of criteria that must be met.

The eligibility criteria for particular packs or collectibles may be determined by a system administrator or by virtue of an automatic survey of the system. The eligibility criteria may be stored in connection with the offering of a pack or collectible. Previously-determined eligibility criteria may also be reused for new offerings of packs or collectibles.

Eligibility criteria may also be set to adjust temporally for particular packs or collectibles, where a first criterion or criteria may be applied during a first time period related to the offering of the pack or collectible, and a second criterion or criteria may be applied during a second, subsequent, time period or periods. In this manner, different access may be provided to the pack or collectible on a temporal basis in any number of successive steps. For example, priority access to particular packs or collectibles may be provided to those users that have a larger reward point balance, or any other applicable criterion or criteria, during a first time period, after which the required reward point balance, or any other applicable criterion or criteria, is lowered.

Collector Score

In one exemplary embodiment, an eligibility criterion is defined by a formula-based collector score defined by a system administrator. The collector score may be point-based, and can include various components that allows a user to qualify to acquire a pack or collectible in a number of ways based on a user's collection of digital collectibles and/or other actions in the system.

For example, a first component of the collector score may be a sum of the points attributable to each of the 3D digital collectibles owned by a user at the time the score is calculated, or within some other identified time frame. Each digital collectible may be assigned a point value based on various attributes of the digital collectible, such as the collectible's current marketplace price, series, rarity, set, and/or other attributes or combinations of the forgoing. The point values may be stored based on input from an administrator (e.g., via the administrator module). If the user has stacked digital collectibles (e.g., multiple instances of the same 3D digital collectible) the points may be separately calculated for each instance, calculated once, or calculated using a formula. In some embodiments, the point value for collectibles in unopened packs (or unopened collectibles in otherwise opened packs), as discussed below, are not counted towards a collector score. In other embodiments, the point value for all collectibles, including those in unopened packs and/or those that are themselves unopened, are counted.

The point value for a collectible may also be based on how the user acquired it. For example, various points may be assigned based on whether the user obtained the digital collectible by purchasing a pack or other offering from the system, by purchasing the digital collectible via the secondary market from another user, by obtaining the digital collectible as a challenge reward, by obtaining the digital collectible through a promotion from the system, and/or other methods of acquisition or combinations of the forgoing.

A collector score may also take into account criteria other than points based on the user's collectibles. For example, any of the actions discussed above that provide reward points may also provide collector score points, such as the completion of a challenge or acquiring a particular set. A user's reward points themselves may also be translated in whole or in part into collector score points. A collector score may also take into account a user status, as discussed above. Various bonuses may also be utilized to enhance the collector score based on any of the above. For example a bonus may be added to the collector score for all users with a “vet” status, or all users that completed a particular challenge, etc. Additionally, various inputs to the formula used to define the collector score may we differently weighted. For example, the fact that a user has a particular number of legendary collectibles may be weighted more heavily than a user's status (e.g., a multiplier may be applied to one portion of the formula and not the other).

As discussed above, a user's collector score may be used as an eligibility criterion to determine whether a user is eligible to purchase a particular pack or 3D digital collectible. Based on a comparison of the eligibility criterion and the user-specific collector score, the system may make a determination of whether the user meets the eligibility criteria for the offered pack, such as is described with regard to FIG. 10.

Table 1 illustrates an exemplary collector score point system.

| Series 1 Collectibles | Series 1 Challenge Rewards |
|---|---|
| Common (Base): 25 points | Common (Base): 37 points |
| Common (Non-Base): 40 points | Common (Non-Base): 60 points |
| Rare: 100 points | Rare: 150 points |
| Legendary: 2000 points | Legendary: 3000 points |
| Series 2 Collectibles | Series 2 Challenge Rewards |
| Common (Base): 12 points | Common (Base): 18 points |
| Common (Promo): 10 points | Common (Promo): 15 points |
| Common (Non-Base): 20 points | Common (Non-Base): 30 points |
| Rare: 80 points | Rare: 120 points |
| Legendary: 1000 points | Legendary: 1500 points |

In accordance with the point system of Table 1, a user with one Series 1 Legendary collectible (2000), four Series 2 Rare collectible (80 each), ten Series 1 common (base) collectibles (25 each) and one Series 2 Rare reward collectible issued as a reward for collecting each of the set of the four Rare collectibles (120 points) would have a total of 2,690 collector score points.

In the above, different collector points are attributable to common collectibles obtained from a base pack (e.g., an initial pack offered to a user when first entering the system), a promotion, and otherwise (non-base).

In some situations, a reward collectible (e.g., a collectible obtained by completing a challenge) was obtained by a user by purchasing it from another user, such as through a system-managed marketplace, not by the user himself completing a particular challenge. To more discretely recognize those users that have completed challenges to obtain a reward collectible, an extra challenge completion bonus may also be added to the collector points. Table 2 illustrates an exemplary challenge completion bonus collector point system.

| Series 1 - Challenge | Series 2 - Challenge |
|---|---|
| Completion + Reward Owned | Completion + Reward Owned |
| Common (Non-Base) = 20 points | Common (Non-Base) = 70 points |
| | Common (Promo) = 35 points |
| Rare = 50 points | Rare = 280 points |
| Legendary = 1000 points | Legendary = 3,500 points |

For example, in the exemplary collector score point calculation detailed above, if the user himself had completed a challenge to obtain the Series 2 Rare reward collectible, an additional 280 points would be added to his collector score, for a total of 2,970 points.

As another example, if the user completed a specific challenge of collecting nine Legendary collectibles and received a Legendary reward collectible, the user would have (at least) the following in his collection: (10) Series 2 Legendary digital collectibles (9 non-rewards, plus one reward): 9,000 points+1,500 points=10,500 points. By virtue of the user himself completing the challenge, he would also receive (1) Series 2 Challenge Completion Bonus of 3,500 points. Thus, the user would have 14,000 collector points. On the other hand, if the user hadn't completed the challenge and just bought the reward on the marketplace, the user would not receive the extra challenge completion bonus.

The points discussed above are exemplary. Any appropriate point distribution may be used.

Offering Bonuses

In some embodiments, certain bonuses or multipliers may be added to a collector score on an offer-by-offer basis for certain packs or collectible offerings. In other embodiments, bonuses or multipliers may be more broadly used.

For example, a particular pack may require a certain collector score (e.g., 2,500) as a criterion for a user to purchase the pack. Bonus points can be added to the collector score for certain users to allow those that do not have 2,500 collector points to be eligible to purchase the pack. The bonus can be based on any of the collector score factors discussed above. Alternatively, the bonus can be based on a measure of how much more money the user has spent on acquiring collectibles in the system, such as via a system marketplace, that he has received by selling collectibles in the system (e.g., a “net spend”).

An example of the collector score bonuses is shown in Table 3, which illustrates how different net spend levels can be translated into a “marketplace bonus” that can be added to a collector score to reach the 2,500 requirement.

| | | Marketplace | Score |
|---|---|---|---|
| | Net Spend Range* | Bonus | required |
| Tier 15 | <$1 | 0 | 2500 |
| Tier 14 | $1-$39.99 | 250 | 2250 |
| Tier 13 | $40-$99.99 | 500 | 2000 |
| Tier 12 | $100-$199.99 | 850 | 1650 |
| Tier 11 | $200-$349.99 | 1000 | 1500 |
| Tier 10 | $350-$499.99 | 1150 | 1350 |
| Tier 9 | $500-$749.99 | 1250 | 1250 |
| Tier 8 | $750-$999.99 | 1400 | 1100 |
| Tier 7 | $1,000-$1,299.99 | 1500 | 1000 |
| Tier 6 | $1,300-$1,649.99 | 1650 | 850 |
| Tier 5 | $1,650-$2,099.99 | 1800 | 700 |
| Tier 4 | $2,100-$2,599.99 | 1900 | 600 |
| Tier 3 | $2,600-$3,199.99 | 2050 | 450 |
| Tier 2 | $3,200-$3,999.99 | 2150 | 350 |
| Tier 1 | $4,000+ | 2300 | 200 |

*Total dollars spent on Marketplace minus total dollars in sales in Marketplace until 11:59 PM PDT, May 31, 2021

In this example, users that have a high net spend in the marketplace will still be able to acquire the offered pack or collectible, although users must still have a minimum collector score.

Another example of collector score bonuses for a more valuable pack or collectible is shown in Table 4.

| | | Marketplace | Score |
|---|---|---|---|
| | Net Spend Range* | Bonus | required |
| Tier 21 | <$1 | 0 | 7500 |
| Tier 20 | $1-$39.99 | 100 | 7400 |
| Tier 19 | $40-$99.99 | 500 | 7000 |
| Tier 18 | $100-$199.99 | 700 | 6800 |
| Tier 17 | $200-$349.99 | 950 | 6550 |
| Tier 16 | $350-$499.99 | 1200 | 6300 |
| Tier 15 | $500-$749.99 | 1400 | 6100 |
| Tier 14 | $750-$999.99 | 1700 | 5800 |
| Tier 13 | $1,000-$1,299.99 | 1900 | 5600 |
| Tier 12 | $1,300-$1,649.99 | 2100 | 5400 |
| Tier 11 | $1,650-$2,099.99 | 2300 | 5200 |
| Tier 10 | $2,100-$2,599.99 | 2600 | 4900 |
| Tier 9 | $2,600-$3,199.99 | 2800 | 4700 |
| Tier 8 | $3,200-$3,999.99 | 3100 | 4400 |
| Tier 7 | $4,000-$4,999.99 | 3400 | 4100 |
| Tier 6 | $5,000-$5,999.99 | 3800 | 3700 |
| Tier 5 | $6,000-$6,999.99 | 4000 | 3500 |
| Tier 4 | $7,000-$7,999.99 | 4300 | 3200 |
| Tier 3 | $8,000-$8,999.99 | 4500 | 3000 |
| Tier 2 | $9,000-$9,999.99 | 4800 | 2700 |
| Tier 1 | $10,000+ | 5000 | 2500 |

*Total dollars spent on Marketplace minus total dollars received from sales in Marketplace from 12:01 am PDT Jan. 31, 2021 until 9:00 am PDT, Jun. 10, 2021

The bonuses described above may be based on a lifetime net spend for a user, or may be set in accordance with a particular time frame (e.g., past month, six months, etc.). In some embodiments, the time frame may correspond to a series time frame for the applicable pack or collectible.

In addition to the net spend bonus, bonuses for particular offerings may be based on any of the challenges or sources of reward points discussed above. For example, a set team bonus may be provided where the user has obtained all the collectibles of a particular set defined by the system. In another embodiment, a series team bonus may be provided where a user has obtained at least one collectible from each available player on a particular team from a particular series (e.g., at least one collectible from each player on the Washington Capitals that has a collectible in the system from the series corresponding to the 2020-2021 NHL season). In another embodiment, a full team bonus may be provided where a user has obtained at least one collectible from each available player on a particular team from all available series (e.g., at least one collectible from each player on the Washington Capitals that has a collectible in the system from each available series). In another embodiment, a completion+reward bonus may be provided where the user has completed a particular challenge in the system and still owns the instance of the reward collectible he received as the reward, or, on some embodiments, another instance of the reward collectible (e.g., a reward collectible that the user bought from another user).

Bonuses may be added directly to a collector score where the collector score is the sole eligibility criterion, as shown above in Tables 3 and 4. Alternatively, bonuses may be individually added to other criteria as part of a formula, as discussed above.

In one embodiment of a set completion bonus, once a user completes a set, the user will receive twice the collector score points for every 3D digital collectible inside of the particular set. In one embodiment of a series team bonus, seven different players from the NBA's Phoenix Suns were featured in collectibles in a first series. If the user collected at least one collectible from each of the players issued in the first series, the user would be granted a 50% point bonus on each of those collectible. In another embodiment of a full team bonus, if the user collected one digital collectible featuring each player to ever play for the Phoenix Suns in all released series, the user would be granted a 150% point bonus on each of those collectibles.

The bonus points and multipliers discussed above are exemplary. Any appropriate point distribution and multipliers may be used.

System

A platform 400 for creating, managing, storing, rendering, offering, trading, and displaying 3D digital collectibles according to an exemplary embodiment of the invention is shown in FIG. 4. FIG. 4 shows system 410 with various modules and engines for creating, managing, storing, rendering, offering, trading, and displaying a 3D digital collectible, system storage 430 for storing data, digital media files, 3D collectibles, user data, collection, pack, series, set, and challenge data, and display 470 for displaying the 3D digital collectible and a general system interface to a user.

System 410 may include a computer server including a processor 412 programmed with computer instructions including an administration module 414, a display generator 416, a rendering engine 418, a gathering engine 420, a collectible creation manager 422, a user account manager 424, a user control module 426, a collection manager 428, a pack manager 429, a series manager 421, a set manager 423, a marketplace manager 425, a challenge manager 427, a scoring manager 417, and a criteria manager 417. Platform 400 may also include a display 470 with 3D display 472, media player 474, and system interface 476. Platform 400 may also include an associated computer memory or system storage 430 that stores a data structure comprising event data 432, actor data 434, context data 436, metadata 438, digital media files 440, 3D collectibles 442, rarity data 444, collection data 446, pack data 448, user data 441, series data 443, set data 445, challenge data 447, scoring data 439, and criteria data 437, associated data/content, and particular association(s) therebetween, including rules that define what is to be displayed on the surfaces, overlay display elements, and surrounding structure of the 3D digital collectible. The components of the systems may be co-located or distributed.

Platform 400 may include tools to define and create a 3D digital collectible, including administration module 414 that manages and tracks ownership of 3D digital collectibles by particular users, gathering engine 420 that collects digital media files and data from event 450 and/or other data sources, and collectible creation manager 422 that creates 3D digital collectibles and defines their data structures and relationships. User account manager 424 is also provided to allow users to create and manage accounts to interact with system 410, and user control module 426 that provides various controls to users to perform any of the steps herein, such as by providing a system interface 476 on display 470 using display generator 416. The system interface may be a webpage, app, portal, or other applicable interface for a user to interact with to perform any of the actions discussed herein.

As part of the process for creating a 3D digital collectible, gathering engine 420 may gather digital media files 452 and data 454 related to an event, either automatically or pursuant to a specific user request. This gathering may include obtaining necessary rights to the digital media files 452 or data 454. Gathering engine 420 may then store collected digital media files 452 in system storage 430 as stored digital media files 440. Gathering engine 420 may also store data 454 in system storage 430 as event data 432, actor data 434, or context data 436, as appropriate. Gathering engine 420 may also gather and store event data 432, actor data 434, and context data 436 from other sources related to event 450, such as other databases or data services related to news, statistics, sports leagues, etc.

Collectible creation manager 422 may use the stored digital media files 440 and one or more of data 432, 434, 436, 438, 443, 444, and 445 to create and categorize a 3D digital collectible and store it in system storage 430 as a stored 3D digital collectible 442. Each stored 3D digital collectible 440 may include rarity data 444, such as the serial number of the predetermined number of copies of the 3D digital collectible in the batch as discussed above, which serves as a globally unique identifier and may be represented as an NFT. Collectible creation manager 422 provides functionality to specify the type of 3D digital collectible (e.g., what n-sided 3D shape is to be used), visual design attributes of the 3D digital collectible (e.g., colors, shading, material, textures, and/or lighting), which digital media file(s) 440 and data 432, 434, 436, 438, 443, 444, and 445 are to be displayed on the 3D digital collectible, how the digital media file(s) and data are to be displayed (e.g., what surfaces the content is to be assigned, how the content is to be shown, played, or listened to, any sequence of display, etc.), whether to provide overlay display elements, including their type, design, and arrangement, and what digital media files, data, or other visual indications are to be displayed thereon (and in what manner), whether to provide surrounding structures, including their type, design, and arrangement, and what data or visual indications are to be displayed thereon (and in what manner), whether to provide a data tag adjacent the 3D digital collectible as it is displayed, including what data to display thereon, a rarity classification of the 3D digital collectible, obtained from rarity data 444, and any other of the related elements discussed herein. Collectible creation manager 422 may provide a GUI for a user to create a 3D digital collectible and select each of the above parameters, or may operate in a partially or fully automatic manner. After each of the parameters above are selected, collectible creation manager 422 may establish associations or links between the 3D digital collectible (such as by using its unique identifier) and any applicable digital media file(s) 440, data 432, 434, 436, 438, 443, 444, and 445, and any other applicable data or design elements, and creates a data structure in memory associating these elements. This data structure is associated with the 3D digital collectible being created and is stored as metadata 438 in system storage 430. In this manner, each 3D digital collectible created by collectible creation manager 422 is unique based on the aspects of the embodiments described herein.

Collectible creation manager 422 may also track and store in metadata 438 all relationships between event data 432, actor data 434, context data 436, rarity data 444, collection data 446, pack data 448, series data 443, set data 445, and digital media files 440 that have been identified with regard to any other 3D digital collectible or are determined to otherwise be related during collection (e.g., event data such as a play may be linked to context data such as the related sports league) such that smart options may be presented by collectible creation manager 422 to a user during creation of the 3D digital collectible.

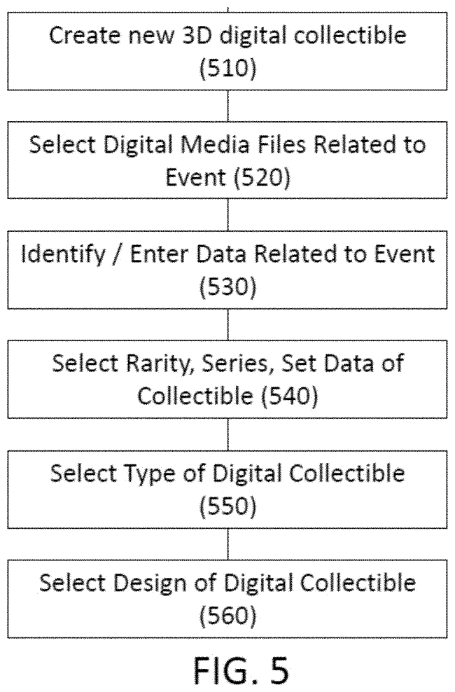

An exemplary 3D digital collectible creation process is illustrated in FIG. 5. The creator (e.g., an user with an account on system 410 as tracked by user account manager 424) may employ any user interface (e.g., a GUI provided by collectible creation manager 424, such as system interface 476) or other input mechanisms to make the following selections and perform the following data entry. In the first step 510, a user may indicate his desire to create a new 3D digital collectible in connection with an event, either from preexisting media or as part of a live event. A unique identifier for the 3D digital collectible may be selected or generated at this stage. In Step 520, one or more digital media files related to the event (e.g., digital media files 440) may be selected and obtained, including obtaining any necessary rights to show, play, or display the digital media file. In step 530, data, such as event data 432, actor data 434, or context data 436 (or other data or content) may be identified, obtained, or entered and stored in a data structure associated with the 3D digital collectible (e.g. as metadata 438). At step 540, additional data, such as collection data 446, pack data 448, series data 443, or set data 445, may be identified, obtained, or entered and stored in a data structure associated with the 3D digital collectible (e.g. as metadata 438). At step 550, the creator may select visual characteristics of the digital collectible, such as a cube or other n-sided 3D shape, an overlay display element configuration, and a surrounding structure configuration, and store them in the data structure associated with the 3D digital collectible (e.g. as metadata 438). At step 560, the creator may select how the digital media files and/or data are displayed, including how the digital media files and data are displayed in relationship to each other and the various formats and features of the digital collectible discussed herein, and store them in the data structure associated with the 3D digital collectible (e.g. as metadata 438). Additionally, with regard to digital media files that include video clips, the creator may identify a picture that can be displayed on the surface of the 3D digital collectible as a representation of the digital media file. In various embodiments, the picture may be a frame of the video clip or any other picture the creator may select. The creator may also specify that different pictures appear with regard to the digital media file in different situations, such as when the 3D digital collectible is in different orientations or after the digital media file has been played once.

According to another aspect of the invention, rules can be created to set forth what digital media files and data is presented on the 3D digital collectible as part of the 3D digital collectible creation process, such as in steps of the exemplary method of FIG. 5. For example, the 3D digital collectible may be designed to present a media file on one surface of the 3D digital collectible (e.g., when a representation of a first surface of the 3D virtual display element is forward facing) and related data on another surface or surfaces of the 3D digital collectible when that surface of the 3D digital collectible is forward facing. As a concrete example of this functionality, for a sporting event, a highlight video can be rendered on a first surface and a team logo can be rendered on an opposite surface.

Rules may be stored in metadata 438, and may be accessed by collectible creation manager 422 during creation of the 3D digital collectible to partially automate creation, such as by automatically populating data 432, 434, 436, 441, 443, 444, or 445 based on selection of a particular digital media file 440, using predefined relationships between these elements as discussed above. Rules may also enforce standardization of the appearance of 3D digital collectibles. For example, rules may define relationships between and among particular digital media files and data, and between particular surfaces of a 3D digital collectible, such that surfaces of a 3D digital collectible may be automatically populated with digital media files and data in any appropriate manner. Digital media files and data may also be classified or categorized by rules. In this manner, specific data (i.e. belonging to a specific classification) and/or digital media files may be rendered at specific surfaces of the n-surfaces of the 3D virtual element and can depend on data values.

Series manager 421 may manage and provide, in conjunction with, for example, administration module 414, algorithms, and various data stored in system storage 430, the functionality described above to allow system managers to create and manage series. For example, series manager 421 may provide an interface for system managers to create a series and add particular collectibles to the series, either manually or automatically according to system rules or database functions. Series manager 421 maintains rules that associate particular collectibles with particular series in the manner discussed above. Series data and related rules may be stored in series data 443. Series manager 421 may at various times, or upon a system request, identify a series and/or track users' completion of series in the manner discussed above, including tracking and granting any applicable rewards.

Set manager 423 may manage and provide, in conjunction with, for example, administration module 414, algorithms, and various data stored in system storage 430, the functionality described above to allow system managers to create and manage sets. For example, set manager 423 may provide an interface for system managers to create a set and add particular collectibles to the set, either manually or automatically according to system rules or database functions. Set manager 421 maintains rules that associate particular collectibles with particular sets in the manner discussed above. Set data and related rules may be stored in set data 445. Set manager 423 may at various times, or upon a system request, identify a set and/or track users' completion of sets in the manner discussed above, including tracking and granting any applicable rewards.

Challenge manager 427 may manage and provide, in conjunction with, for example, administration module 414, algorithms, and various data stored in system storage 430, the functionality described above to allow system managers to create and manage challenges. For example, challenge manager 427 may provide an interface for system managers to create a challenge, including by identifying particular collectibles to obtain as part of the challenge, either manually or automatically according to system rules or database functions. Challenge manager 427 maintains rules that associate particular collectibles with particular challenges in the manner discussed above. Challenge data and related rules may be stored in challenge data 447. Challenge manager 427 may at various times, or upon a system request, set a challenge for users and/or track users' completion of challenges in the manner discussed above, including tracking and granting any applicable rewards.

Scoring manager 419 may manage and provide, in conjunction with, for example, administration module 414, algorithms, and various data stored in system storage 430, the functionality described above to allow system managers to create and manage scoring parameters related to various collectibles and user actions. For example, scoring manager 419 may provide an interface for system managers to create scoring parameters, including by identifying particular points attributable to particular collectibles, either manually or automatically according to system rules or database functions. Scoring manager 419 maintains rules that associate particular points with particular collectibles or user actions in the manner discussed above. Scoring data and related rules may be stored in scoring data 439. Scoring manager 419 may at various times, or upon a system request, determine scoring parameters and/or calculate users' scores in the manner discussed above. Scoring module may also provide scoring for users' reward points in the manner discussed above.

Criteria manager 417 may manage and provide, in conjunction with, for example, administration module 414, algorithms, and various data stored in system storage 430, the functionality described above to allow system managers to create and manage criteria related to various collectibles or packs. For example, criteria manager 417 may provide an interface for system managers to create particular criteria, including by identifying particular necessary criteria for a user to obtain a particular collectible or pack, either manually or automatically according to system rules or database functions. Criteria manager 417 maintains rules that associate particular criteria with particular collectibles or packs in the manner discussed above. Criteria data and related rules may be stored in criteria data 437. Criteria manager 417 may at various times, or upon a system request, determine criteria parameters and/or set criteria for particular sets or collectibles in the manner discussed above.

Administration module may interface with, using algorithms and related data from system storage 430, set manager 423, series manager 421, challenge manager 427, scoring manager 419, criteria manager 417, and user account manager 424 to provide the functionality discussed herein, such as identifying sets, series, challenges, scoring parameters, and eligibility criteria in the system, completion status of users as to identified sets, series, and challenges, determining users' collector scores, determining whether users meet particular eligibility criteria, and the other functions discussed above. Administration module 414 may also interface with user account manager 424 and/or scoring manager 419 to calculate, grant, and track users' reward points.

Marketplace manager 425 may manage functionality for buying, selling, and trading packs or collectibles as discussed herein.

Platform 400 may also include tools to display 3D digital collectibles and system interfaces, such as display generator 416 and rendering engine 418 for generating graphical user interfaces (GUIs) for displaying a 3D digital collectible for display therein to a user via 3D display 472 on display 470. For example, the 3D digital collectible (e.g. the digital media file and data) may be configured to be displayed as a 3D display element. The digital collectible can be represented as, or otherwise include, the 3D display element. The 3D display element can be in a virtual 3D graphical interface. The 3D display element can have n-surfaces which are combined together into an n-sided 3D shape, (cube, sphere, pyramid, octagon, etc.), overlay display elements, and surrounding structure. Each face or side of the of the n-sided shape can display at least one of the aforementioned digital media and/or data types. Each face or side of the n-sided shape can have associated digital media and/or context data of a specific type (for example, belonging to a specific classification of media, such as images, video, text, sound for playback, etc.). The overlay display elements can also display at least one of the aforementioned digital media and/or data types.

The display generator 416 and rendering engine 618 may generate a GUI on display 470, the representation of the 3D digital collectible and a media player for playing the digital media file(s) included with the 3D digital collectible based on scripted or user selected commands. The interface may be configured to display the 3D digital collectible as the virtual, three dimensional n-sided structure discussed above. The display may be pre-rendered or rendered in real-time as it is being displayed. The 3D digital collectible may be rendered and displayed in any orientation, such as the perspective and plan views of FIGS. 1a-1f, may be stationary in one view, or may change orientation between views (e.g., rotate, translate, etc.) either automatically based on elapsed time, in reaction to a user interaction (e.g., mouse click, scroll bar movement, or touch interface), or both. Display generator 416 may also generate a system interface 476, such as a GUI, on display 470 for users to interact with the system in the manner discussed herein.

When a surface of 3D digital collectible that includes a digital media file is facing a user, the digital media may be displayed on that surface (or on an overlay display element, as discussed below). For example, in FIG. 1a, a digital media file 115 is visible on surface 110 of the 3D cube. If the digital media file is a video and/or audio track, display of the surface containing that digital media file also allows the video or audio to play. For example, in FIG. 1a, if the displayed digital media file 115 is a video, it may play in the orientation shown.

In other embodiments, a separate media player may be generated in the GUI by display generator 416 and rendering engine 618 to play digital media files and/or data from surfaces of the 3D digital collectible (and/or overlay display elements), such as in an window or pop-up adjacent to the 3D digital collectible. The media player may also partially or fully overlay the 3D digital collectible, hover over a surface of the 3D digital collectible, or simply replace the 3D digital collectible in the GUI. The media player may automatically launch and begin playing when a surface of the 3D digital collectible with an appropriate digital media file is visible, or upon user command. The media player may be of any shape and orientation to play the media file. Additionally, the view of the media player can be changed by further user interaction. For example, the media player may be maximized on the user screen for easier viewing automatically or based on user command. Selectors may also be provided to perform other display changes, or to launch a separate viewer or application.

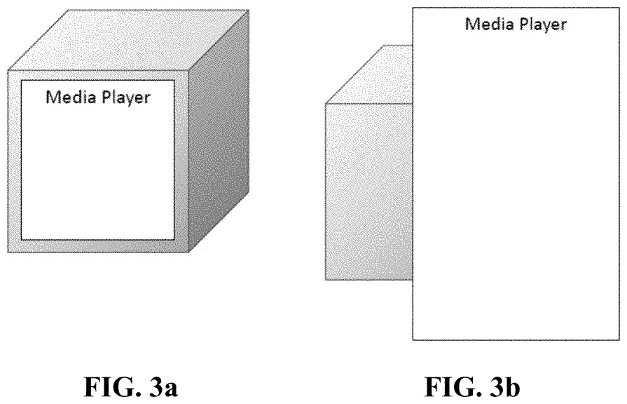

FIGS. 3A and 3B illustrate exemplary embodiments of media player 474. FIG. 3A provides the media player over the surface of the 3D digital collectible, while FIG. 3B shows the media player partially overlaying the 3D digital collectible. In either of these embodiments, the 3D digital collectible and media player may be provided in the same window, or in separate windows or popups. In any of the embodiments discussed above, the media player may be partially transparent such that portions of the 3D digital collectible under the media player are still visible. In any of the embodiments herein, various playback features may also be implemented to allow the user more control of the playback, such as play, pause, rewind, and replay buttons. Such controls may be placed on the surface where the digital media file is shown, on the media player, or may be arranged thereto or anywhere else in the GUI.

In the above embodiments, the GUI and/or the media player may be configured to play the digital media file upon a direct user request, or automatically (e.g., according to timing or positioning of the 3D digital collectible). For example, the GUI may be configured such that when a surface of the 3D digital collectible depicting a representation of a media file is forward facing, a script or user command may cause the media player to play one or more media files representing the event. As discussed above, the digital media files may comprise a video clip of the event or multiple clips of the event from different perspectives. The multiple clips may be associated with the collectible in a data structure stored in the memory. The multiple clips may be played sequentially (e.g., in accordance with a script) or they may be stitched together in a specified order to create a single file.

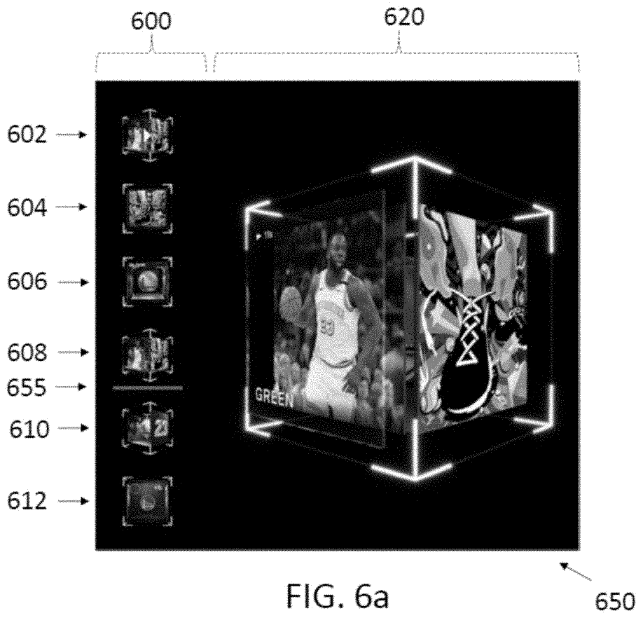

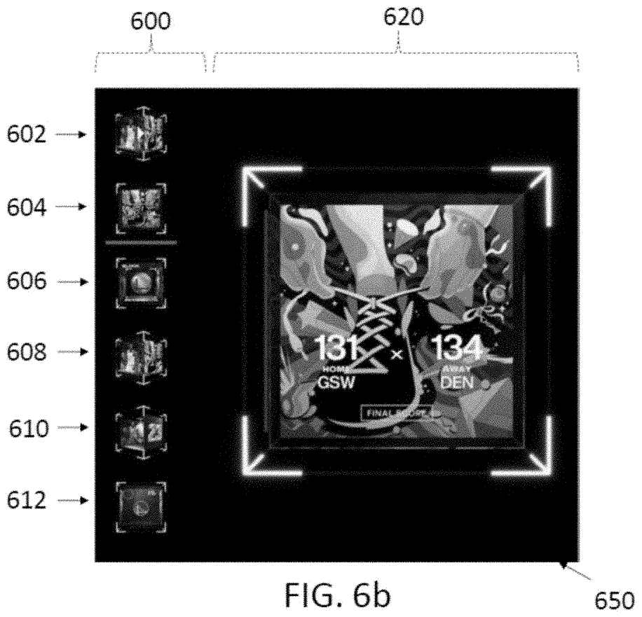

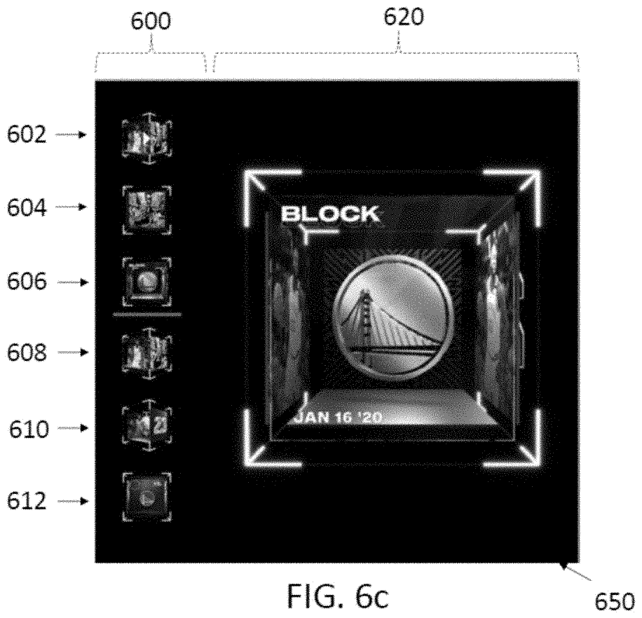

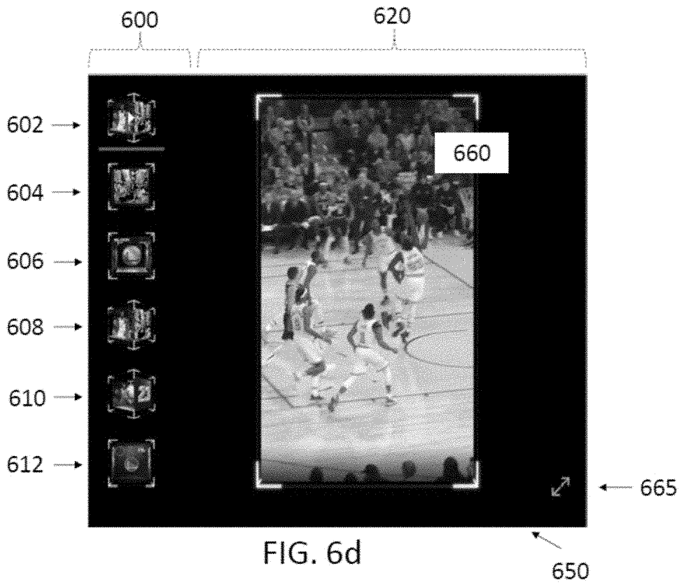

According to another exemplary embodiment, the GUI may be an interactive display. For example, in response to user input selections via the graphical user interface different surfaces of the n-sided display may be displayed. For example, as shown in FIGS. 6a-6d, GUI 650 may be configured to include a first display portion 600 with a multiple icons 602, 604, 606, 608, 610, 612 and second display portion 620 that shows various views of a 3D digital collectible corresponding to the icons. As shown in FIG. 6d, media player 660 may also be launched in second display portion 620. Features of an interactive display are described in more detail in U.S. application Ser. No. 17/229,430 titled “System and Method for Creating, Managing, and Displaying an Interactive Display for 3D Digital Collectibles,” filed Apr. 13, 2021, hereby incorporated by reference in its entirety.

Managing a Collection of 3D Digital Collectibles

According to other aspects of various embodiments, a user may manage the display of multiple digital collectables within their account through collection manager 428. For example, in some embodiments, the digital collectables may be stored online (e.g., under control of the system), a user may create one or more collections of digital collectables and share a link or other identifier associated with the collection and other users may use the link or other identifier to view the collection(s). Data related to the collection may be stored as collection data 446. Collections are described in more detail U.S. application Ser. No. 17/229,430 titled “System and Method for Creating, Managing, and Displaying an Interactive Display for 3D Digital Collectibles,” filed Apr. 13, 2021, hereby incorporated by reference in its entirety.

Overlays and Markers

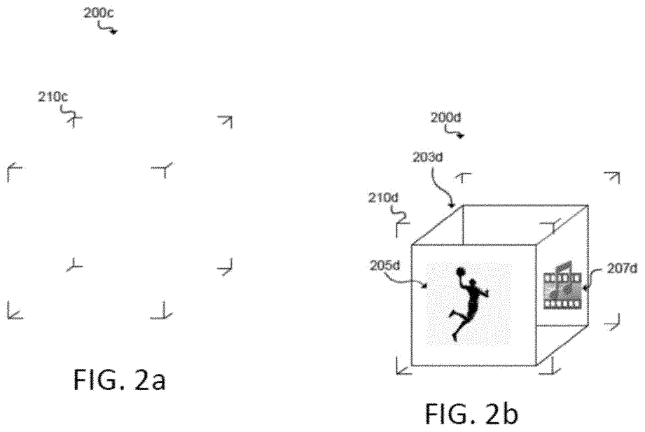

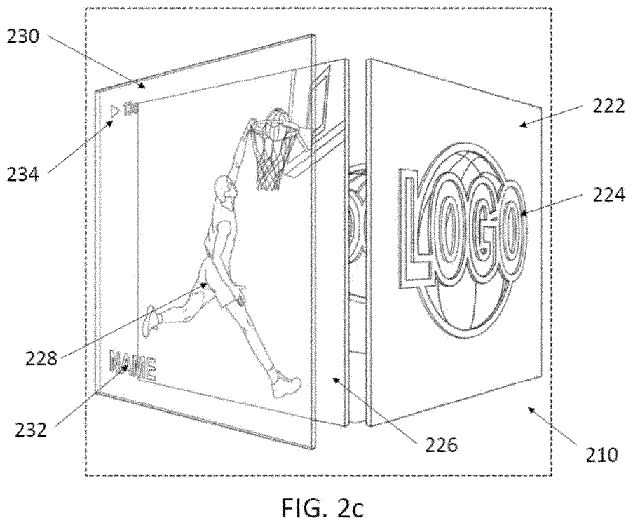

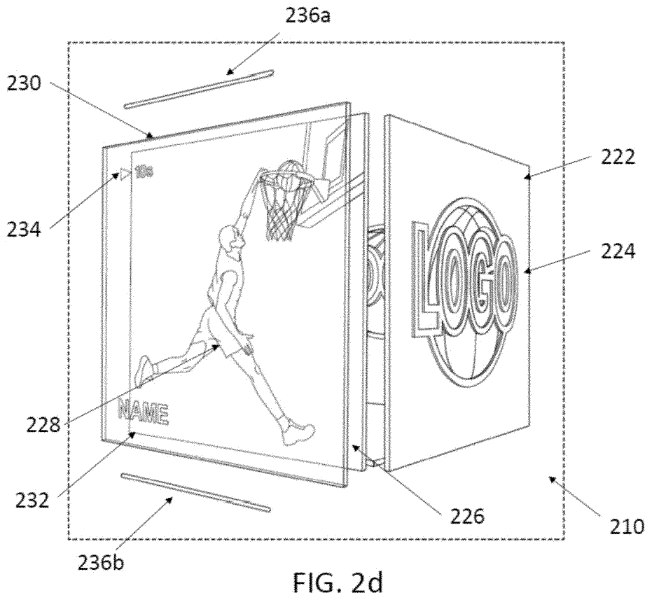

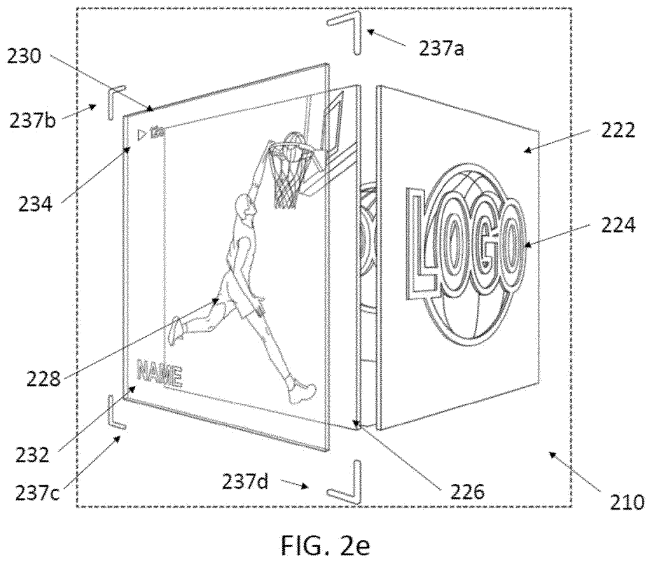

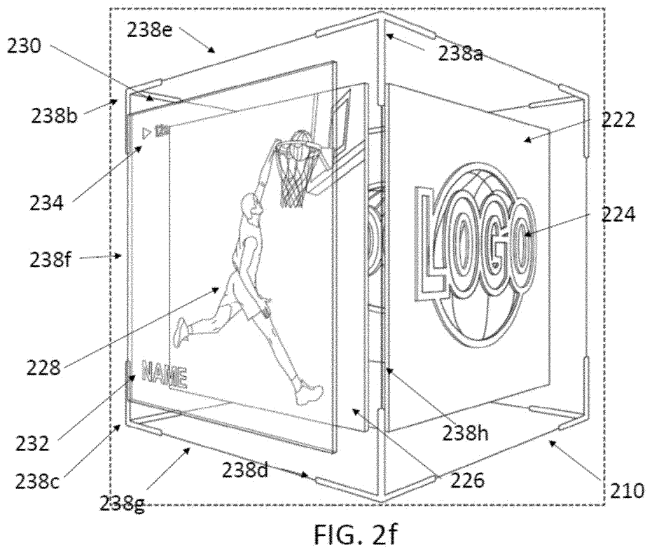

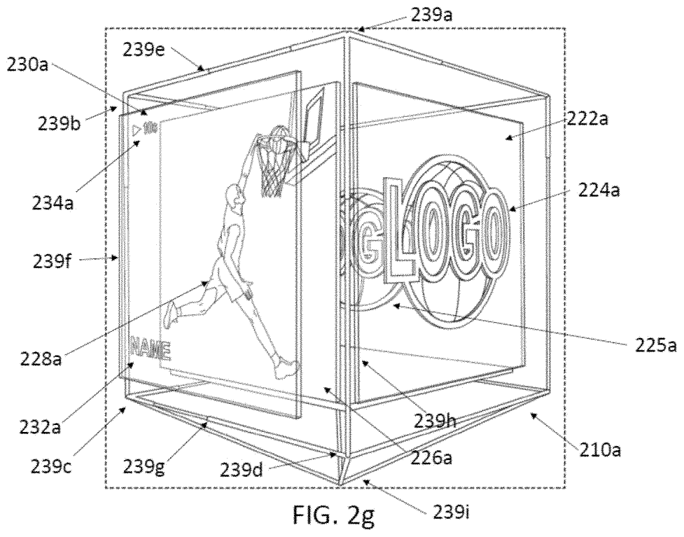

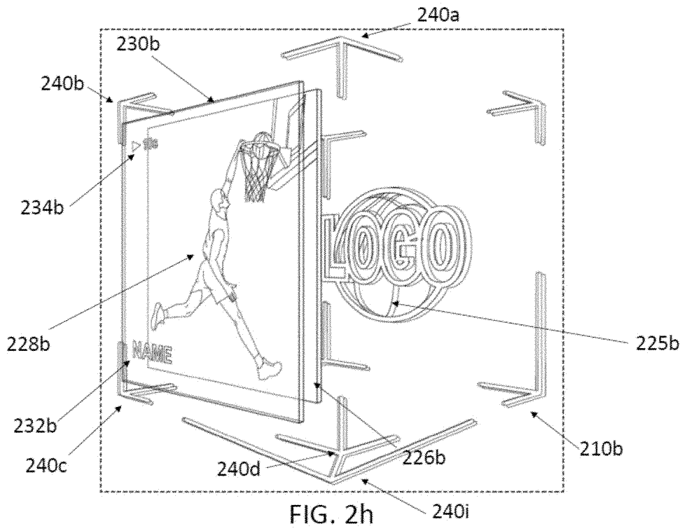

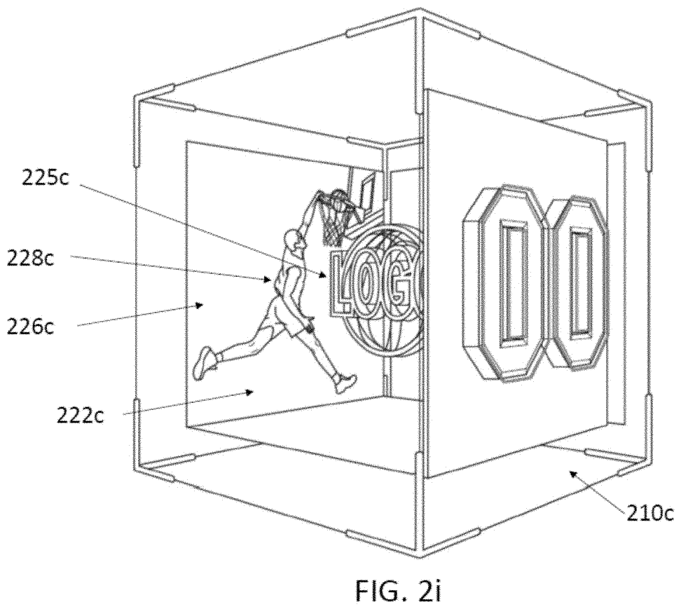

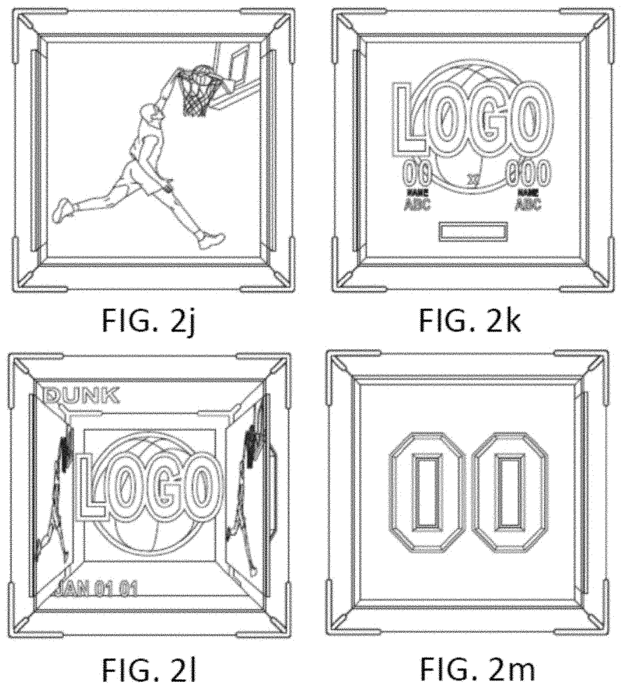

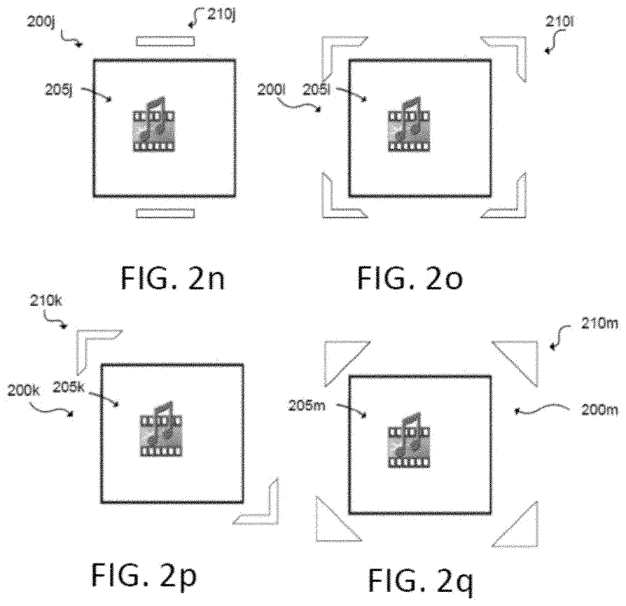

FIGS. 2a-2q show further exemplary embodiments of 3D digital collectibles that include one or more of the features discussed above, along with various additional features.

In some embodiments, a 3D digital collectible may also include surrounding structure display elements. Surrounding structure display elements include a framework that at least partially surrounds the n-sided 3D shape.

A framework may include visible markers or lines that at least partially define edges or shapes of the framework at least partially surrounding the underlying 3D digital collectible structure. The markers or lines may be provided, or may be provided in various colors, shades, and opacities, to provide a visual indication of attributes of the 3D digital collectible and/or the content thereof. For example, a particular marker shape and color may be utilized to indicate a rarity classification or other attribute of the 3D digital collectible, such as a series or set of which the collectible is a part. Marker and line shapes, colors, and opacities may also represent any of the other data categories mentioned herein.

In FIG. 2a, an exemplary surrounding structure related to 3D digital collectible 200c is shown. In this embodiment, the surrounding structure is a set of eight markers 210c. In FIG. 2b, the exemplary surrounding structure of FIG. 2a is portrayed about a 3D cube shape 200d with surfaces 203d including a first digital media file 205d (e.g. video, image, and/or sound), and a second digital media file 207d (e.g. video, image, and/or sound) displayed thereon. In FIG. 2b, seven of the eight markers 210d remain visible. In exemplary embodiments, the markers can be rendered in a color, brightness, opacity different from the 3D cube shape 200d (or with any other visible distinction) to indicate something about the 3D digital collectible, such as the rarity classification or other data discussed above.

In some embodiments, a 3D digital collectible may also include an overlay display element, or glass. Glass may include at least partially transparent planar objects positioned over at least one surface of the n-sided 3D shape. Other appropriate 3D shapes may also be used (e.g., domes, pyramids, etc.) adjacent one or multiple surfaces of the n-sided 3D shape. The glass may display digital media files, data or other content in the same manner discussed above regarding a surface of the n-sided 3D shape. The glass may also display content that has a specific relationship to the digital media file or other content on the surface of the n-sided 3D shape over which the glass is arranged. For example, a glass arranged above a surface of the n-sided 3D shape that displays a digital media file of an event (e.g., a video of a dunk) may display data related to the event (e.g., displaying the player's name overlaying the video of the dunk), or data related to the collectible, such as rarity, series, or set data. The glass itself, and the data or digital media displayed thereon, may be of varying transparencies such that the digital media file on the surface of the n-sided 3D shape is visible through the glass and data. The content to be displayed on glass, and the manner in which it is displayed, can be specified during the creation process in the manner discussed above.

FIGS. 2c-2h show various embodiments of overlay display elements and surrounding structure, including various configurations of framework and glass. In some embodiments, these different configurations may denote different rarity classifications, series, or sets. In other embodiments, these different configurations may denote other categorical differences, or simply design preferences.

FIG. 2c shows exemplary n-sided 3D shape 210 with glass 230 rendered such that it overlays at a first distance a first surface 226 of n-sided 3D shape 210 with a digital media file 228 thereon. In this embodiment, no glass is rendered above second surface 222 of n-sided 3D shape 210, which displays data 224, in this case a logo relevant to the digital media file 228. In other embodiments, multiple glasses can be rendered. As shown in FIG. 2c, glass 230 is rendered to be clear. Glass 230 may be of any color or opacity as compared to surface 226 that permits viewing of digital media file 228. In some embodiments, FIG. 2c represents how a 3D digital collectible would be displayed when the 3D digital collectible has a first rarity classification (or is of a particular series or set). For example, FIG. 2c may represent how a 3D digital collectible would be displayed where the rarity classification is as a least rare 3D digital collectible (e.g., a “common” 3D digital collectible).

As shown in FIG. 2c, glass 230 is rendered to display data including a name 232 of a player in digital media file 228 and an indication 234 that digital media file is a video clip that may be played as described herein. By rendering name 232 and indication 234 on glass 230, name 232 and indication 234 appear to be floating over digital media file 228. In some embodiments, the data displayed on glass 230 may be static. In other embodiments, the data may be dynamically updated. For example, indication 234 may display a running time of the digital media file 228, or a time remaining of the digital media file being played as discussed herein. In this embodiment, glass 230 does not have any identifiable borders or edges. Glass 230 may include borders or edges of a different color or opacity in other embodiments. In some embodiments, the data displayed on glass 230 may include a rarity value or classification (e.g., a textual or numeric indication), such as by displaying the information in tag 185 in FIG. 1f, or may indicate the collectible is in a particular series or set. In some embodiments, the color or transparency of glass 230 may also be adjusted to indicate a rarity value or classification, or an indication of series or set.

FIG. 2d shows another embodiment of the 3D digital collectible shown in FIG. 2c, where overlay lines 236a and 236b are rendered in addition to glass 230 in the same plane. Lines 236a and 236b may be of the same or different color and opacity as glass 230. In the embodiment of FIG. 2d, lines 236a and 236b are opaque in comparison to overlay 230 for easy visibility. When a non-planar glass is used, such as a dome or pyramid, lines can be rendered such that they appear to be part of an extension of the shape of the glass surface. In some embodiments, FIG. 2d represents how a 3D digital collectible would be displayed when the 3D digital collectible has a second rarity classification (or another series or set). For example, FIG. 2d represents how a 3D digital collectible would be displayed where the rarity classification is reflective of a second least scarce 3D digital collectible (e.g., a “rare” 3D digital collectible). A rarity value or classification (or an indication of series or set) may also be indicated by adjusting the appearance of glass 230 or lines 236a, 236b. For example, lines 236a, 236b can be of a different color, highlights, reflectivity, or the like than glass 230 or the underlying 3D digital collectible structure 210.

FIG. 2e shows another embodiment of the 3D digital collectible shown in FIG. 2c, where a framework, including markers 237a, 237b, 237c, and 237d, is rendered in addition to glass 230 in the same plane. Markers 237a, 237b, 237c, and 237d may be of the same or different color and opacity as glass 230. In the example of FIG. 2e, markers 237a, 237b, 237c, and 237d are opaque in comparison to overlay 230 for easy visibility. When a non-planar glass is used, such as a dome or pyramid, markers can be rendered such that they appear to be part of an extension of the shape of the glass surface. In some embodiments, FIG. 2e represents how a 3D digital collectible would be displayed when the 3D digital collectible has a third rarity classification (or another series or set). For example, FIG. 2e represents another embodiment of how a 3D digital collectible would be displayed where the rarity classification is reflective of a second least scarce 3D digital collectible (e.g., a “rare” 3D digital collectible). A rarity value or classification (or an indication of series or set) may also be indicated by adjusting the appearance of glass 230 or markers 237a, 237b, 237c, and 237d. For example, markers 237a, 237b, 237c, and 237d can be of a different color, highlights, reflectivity, or the like than glass 230 or the underlying 3D digital collectible structure 210.

FIG. 2f shows another embodiment of the 3D digital collectible shown in FIG. 2c, where a framework with markers (e.g., 238a, 238b, 238c, and 238d) and lines (e.g., 238e, 238f, 238g, and 238h) is rendered in a three dimensional shape surrounding the n-sided 3D shape 210 in conjunction with glass 230. Markers (e.g., 238a, 238b, 238c, and 238d) and lines (e.g., 238e, 238f, 238g, and 238h) may be of the same or different color and opacity as overlay 230. The markers and lines may also be of different color, opacity, and thickness relative to each other. In some embodiments, FIG. 2e represents how a 3D digital collectible would be displayed when the 3D digital collectible has a fourth rarity classification (or another series or set). For example, FIG. 2f represents how a 3D digital collectible would be displayed where the rarity classification is reflective of a third least scarce 3D digital collectible (e.g., a “legendary” 3D digital collectible). A rarity value or classification (or an indication of series or set) may also be indicated by adjusting the appearance of glass 230, markers (e.g., 238a, 238b, 238c, and 238d), or lines (e.g., 238e, 238f, 238g, and 238h). For example, markers (e.g., 238a, 238b, 238c, and 238d), or lines (e.g., 238e, 238f, 238g, and 238h) can be of a different color, highlights, reflectivity, or the like than glass 230 or the underlying 3D digital collectible structure 210.

In some embodiments of 3D digital collectibles, one or more of the surfaces of the n-sided 3D shape may be made transparent. FIG. 2g shows such an embodiment of a 3D digital collectible with a transparent surface. FIG. 2g shows exemplary n-sided 3D shape 210a with glass 230 rendered such that it overlays at a first distance a first surface 226a of n-sided 3D shape 210a with a digital media file 228a thereon. In this embodiment, no glass is rendered above second surface 222a of n-sided 3D shape 210a, which displays data 224a, in this case a logo relevant to the digital media file 228a. In other embodiments, multiple glasses can be rendered. As shown in FIG. 2g, surface 222a is transparent such that the structure of n-sided 3D shape 210a can be seen therethrough. Further, in this embodiment, further data may be displayed in the volumetric center of the n-sided 3D shape, such as data 225a. Because surface 222a is transparent, data 225a is visible. Glass 230a may be of any color or opacity as compared to surface 226a that permits viewing of digital media file 228a. In some embodiments, FIG. 2g represents how a 3D digital collectible would be displayed when the 3D digital collectible has a fifth rarity classification (or another series or set). For example, FIG. 2g may represent how a 3D digital collectible would be displayed where the rarity classification is as second most rare 3D digital collectible (e.g., a “platinum ultimate” 3D digital collectible).

As shown in FIG. 2g, glass 230a is rendered to display data including a name 232a of a player in digital media file 228a and in indication 234a that digital media file is a video clip that may be played as described herein. By rendering name 232a and indication 234a on glass 230a, name 232a and indication 234a appear to be floating over digital media file 228a. In some embodiments, the data displayed on glass 230a may be static. In other embodiments, the data may be dynamically updated. For example, indication 234a may display a running time of the digital media file 228a, or a time remaining of the digital media file is being played as discussed herein. Glass 230a may include borders or edges of a different color or opacity in other embodiments. In some embodiments, the data displayed on glass 230 may include a rarity value or classification (e.g., a textual or numeric indication), such as by displaying the information in tag 185 in FIG. if (or an indication of series or set). In some embodiments, the color or transparency of glass 230a may also be adjusted to indicate a rarity value or classification (or an indication of series or set).

FIG. 2g further provides a framework with markers (e.g., 239a, 239b, 239c, and 239d) and lines (e.g., 239e, 239f, 239g, and 239h) rendered in a three dimensional shape surrounding the n-sided 3D shape in conjunction with glass 230a. Markers (e.g., 239a, 239b, 239c, and 239d) and lines (e.g., 239e, 239f, 239g, and 239h) may be of the same or different color and opacity as overlay 230. The markers and lines may also be of different color, opacity, and thickness relative to each other.

As discussed above, in some embodiments of 3D digital collectibles, a surrounding structure may be arranged around an n-sided 3D shape with a 3D shape different from that of the n-sided 3D shape. For example, in FIG. 2g, lines 239i are arranged so as to form a pyramid over the bottom surface (in this view) of the n-sided 3D shape. Any other appropriate shape may be provided by appropriate design of markers and edges.

In some embodiments, only selected surfaces of an n-sided 3D shape are rendered in conjunction with one or more of markers, lines, and glass to form an overall 3D shape. FIG. 2h shows such an embodiment of the a 3D digital collectible with only selected surfaces of the n-sided 3D shape rendered. FIG. 2h shows exemplary n-sided 3D shape 210b with a glass 230b rendered such that it overlays at a first distance a first surface 226b of the n-sided 3D shape 210b with a digital media file 228b thereon. No other surface of n-sided 3D shape is rendered. As shown in FIG. 2h, because other surfaces are not rendered, data displayed in the volumetric center of the 3D digital collectible, such as data 225b, is visible. Glass 230b may be of any color or opacity as compared to surface 226b that permits viewing of digital media file 228b. In some embodiments, FIG. 2h represents how a 3D digital collectible would be displayed when the 3D digital collectible has a sixth rarity classification (or another series or set). For example, FIG. 2g may represent how a 3D digital collectible would be displayed where the rarity classification is as the most rare 3D digital collectible (e.g., a “genesis ultimate” 3D digital collectible).

As shown in FIG. 2h, glass 230b is rendered to display data including a name 232b of a player in digital media file 228b and an indication 234b that digital media file is a video clip that may be played as described herein. By rendering name 232b and indication 234b on glass 230b, name 232b and indication 234b appear to be floating over digital media file 228b. In some embodiments, the data displayed on overlay 230b may be static. In other embodiments, the data may be dynamically updated. For example, indication 234b may display a running time of the digital media file 228b, or a time remaining of the digital media file is being played as discussed herein. Glass 230b may include borders or edges of a different color or opacity in other embodiments. In some embodiments, the data displayed on glass 230b may include a rarity value or classification (e.g., a textual or numeric indication), such as by displaying the information in tag 185 in FIG. if (or an indication of series or set). In some embodiments, the color or transparency of glass 230a may also be adjusted to indicate a rarity value or classification (or an indication of series or set).

FIG. 2h further provides a framework with markers (e.g., 240a, 240b, 240c, and 240d) rendered in a three dimensional shape surrounding the n-sided 3D shape in conjunction with glass 230b. The markers may be of varying shapes and sizes to represent to a viewing the outline of a 3D shape. Lines may also be provided to portray the shape, but are omitted in this embodiment. Markers (and lines) may be of consistent or inconsistent shape and size. For example, in FIG. 2h, marker 210b is of a different shape than markets 240a and 240b, which are of a similar shape. Markers (and lines) may be of the same or different color and opacity as overlay 230b. The markers (and lines) may also be of different color, opacity, and thickness relative to each other.

FIG. 2i provides another example embodiment where surface 222c of n-sided 3D shape 210c is not rendered such that data displayed in the volumetric center of the 3D digital collectible, such as data 225c, is visible. Additionally, internal sides of particular surfaces of the n-sided 3D shape 210c may also be seen when a particular surface is not rendered, such as is shown in this embodiment. For example, internal side of surface 226c showing digital media file 228c may be seen.

In some embodiments, a user may adjust the orientation of the 3D digital collectible, either by direct manipulation (e.g., click and drag) in a GUI or by particular user interfaces, such as described elsewhere herein. In some embodiments, the overlay display element and/or surrounding structure will remain fixed in relation to the n-sided 3D shape e as its orientation is changed. In other embodiments, all or portions of the overlay display element and/or surrounding structure may remain in place as the orientation of the n-sided 3D shape e is changed. In some embodiments, the orientation of the overlay display element and/or surrounding structure may be changed while the orientation of the n-sided 3D shape remains fixed. For example, a user may slide, translate, or rotate the overlay display element in relation to the 3D display element, or in conjunction with the 3D display element. In other embodiments, the overlay display element and/or surrounding structure and n-sided 3D shape may both change orientation to result in different relationships therebetween.

FIGS. 2j-2m provide additional embodiments showing interactions between n-sided 3D shape 290 and overlay display element 292. For example, where a glass is arranged adjacent a surface of the n-sided 3D shape displaying data, glass may display additional data, such as a score as shown in FIG. 2k. In another example, glass may display an event description and date in conjunction with surface displaying data, such as is shown in FIG. 2l. Glass may also be blank when arranged adjacent surfaces, such as is shown in FIGS. 2j and 2m. In other embodiments any data or digital media file may be displayed on glass when it is arranged adjacent a surface of the n-sided 3D shape displaying any other data or digital media file (or where the surface of the n-sided 3D shape is not rendered).

When the orientation of the 3D digital collectible is changed, or the orientation of the n-sided 3D shape and overlay display element and/or surrounding structure relative to each other, the digital media file or data shown in glass may change. For example, glass position may change relative to n-sided 3D shape between FIGS. 2k and 2l, and the data displayed on glass will change.

In the above embodiments, the type(s) of overlay display element(s) and/or surrounding structure (e.g. attributes thereof, the surface of the n-shape that glass overlays, the type and/or number of markers or lines, etc.) can depend on the data associated with the 3D digital collectible, the event data, actor data, context data, rarity data, and/or metadata. For example, the configurations of the surrounding structure may depend on and correspond to the rarity of the digital collectible.

FIGS. 2n, 2o, 2p, 2q, depict exemplary embodiments of digital collectibles with surrounding structure with various types of markers and lines. FIG. 2n shows digital collectible 200j with digital media file 200j and one or more bar-shaped lines 210j. FIG. 2o shows digital collectible 200k with digital media file 205k and corner-shaped markers 210k. FIG. 2p shows digital collectible 200l with media 205l and markers 210l. In this embodiment, only two markers are rendered. Any number of markers or lines may be rendered to serve the purposes of the framework described herein. Finally, FIG. 2q shows digital collectible 200m with digital media file 205m and triangular-shaped markers 210m. Various additional shapes for markers may be used, as well as various combinations thereof.

Packs

In an exemplary embodiment, 3D digital collectibles can be provided to users (e.g., by sale or trade) in a digital pack, or set of different 3D digital collectibles. These packs may be digitally rendered on a graphical user interface in a manner similar to that of the 3D digital collectibles discussed above. The packs may be configured by a system administrator and in accordance with a set of rules and data parameters.

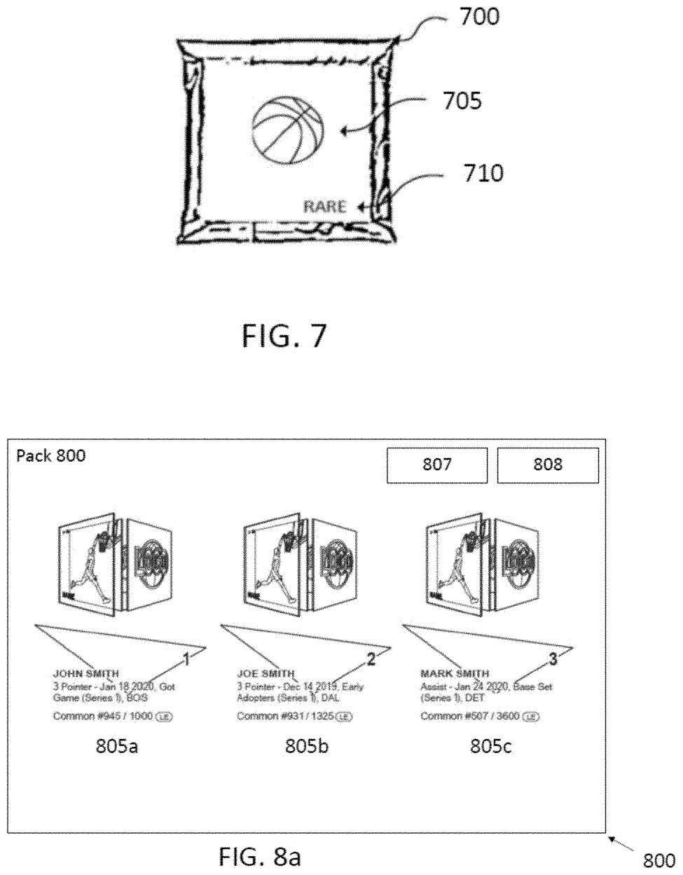

FIG. 7 depicts an exemplary embodiment of a pack 700, as it may be displayed on a GUI. The pack 700 may be rendered in any fashion that would represent a set of 3D digital collectibles to a user. In this embodiment, pack 700 is rendered to resemble a physical pack of trading cards. Pack 700 includes graphical data 705 or other data, including event, context and/or metadata 210 associated to the collectibles in the pack. For example, pack 700 can include representations of the dates of the events of its constituent digital collectibles, the actors in the events, and the like. Pack 700 may also include an indication of the number of 3D digital collectibles contained therein. However, according to some embodiments, the individual items of the pack may not be revealed at this level of display.

Pack 200 may also include a rarity indication 210 that indicates the rarity classification of one or more of the 3D digital collectibles contained in the pack 200. In this embodiment, the rarity indication 210 is “rare,” which indicates that at least one of the 3D digital collectibles of pack 200 is a “rare” 3D digital collectible. Other visual indicators may be used to signify a rarity classification for the pack, such as colors, fonts, designs, holograms, and the like. Other data, such as series data, may also be similarly displayed.

According to some embodiments, different 3D digital collectibles from different batches may bundled into packs. Each pack may comprise only 3D digital collectibles of a single rarity classification, series, or set. In other cases, a pack may include 3D digital collectibles of a more than one rarity classification, series, or set. The pack configurations may be determined by a system administrator. Where the pack contains 3D digital collectibles of more than one rarity classification, the system will apply rules to determine what rarity indication to display on the pack. For example, rarity indication may be set to indicate the most rare rarity classification of any of the 3D digital collectibles in the pack (e.g., if at least one 3D digital collectible is “rare,” the indication 210 will be “rare.”), a rarity classification of the majority of the 3D digital collectibles in the pack, or any other desired configuration. The display of series or set information may be similarly determined. In another embodiment, all of the applicable rarity, series, or sets of the included collectibles may be displayed.

Pack 700 may also be rendered with one or more colors, shading, lighting, and/or textures. The colors, shading, material, textures, and/or lighting can correspond to values of the data, such as event data, context data, rarity data, metadata, series data, set data, and/or any other data discussed herein for one or more digital collectibles within the pack 700. In exemplary embodiments, packs may be rendered as shiny or holographic.

In some embodiments, a user seeking to acquire a pack 700 may not be permitted to see the specific 3D digital collectibles that are part of pack 700 before it is purchased. In other embodiments, some amount of data relating to the pack, such as event data, context data, rarity data, metadata, series data, set data, and/or any other data discussed herein corresponding to the pack may be shared. For example, the rarity classification of a pack or at least one of the 3D digital collectibles of the pack may be indicated as discussed above (e.g., ultimate, legendary, rare, or common).

In some embodiments, the pack can be visually represented as user-manipulatable packaging icon (e.g. square, rectangular other shape) that can be digitally “opened.” For example, the pack can be “opened” by user interactions, such as by clicking a button, virtually tearing the pack, or other appropriate manipulation.

A GUI may display a separate icon for each of the packs associated with the user account. After acquisition and opening by a user, an icon representing each of the 3D digital collectibles associated with the pack may be displayed in a grid, carousel, or other arrangement for viewing. The manner in which the 3D digital collectibles icons spread out of the pack (i.e. a visual representation thereof) may depend on one or more values of related data, such as event data, context data, or metadata. The display may be similar to that of a collection as described in more detail in U.S. application filed May 3, 2021 as U.S. application Ser. No. 17/306,185, titled “System And Method For Creating, Managing, And Displaying User Owned Collections Of 3D Digital Collectibles,” hereby incorporated by reference in its entirety.

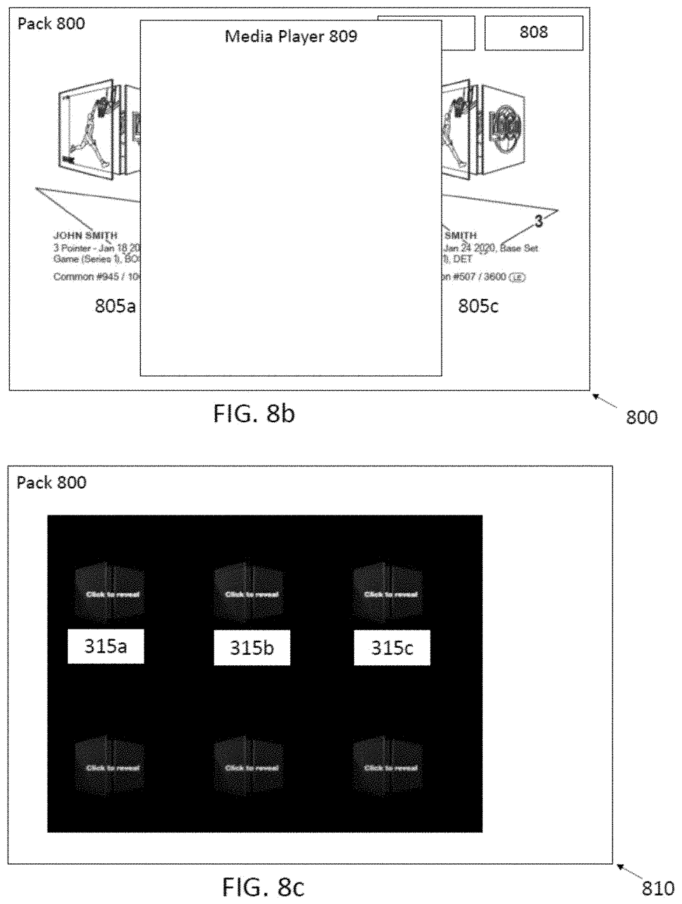

For example, in some embodiments, GUI 800 will display the 3D digital collectibles icons in pack 700 as shown in FIG. 8a. In this example, pack 700 includes three (or other number of) individual 3D digital collectibles. GUI 800 may display the individual 3D digital collectibles icons of pack 700 in any manner. In the FIG. 8a embodiment, each individual 3D digital collectible icon is shown in a grid in a perspective view with a digital media file on one surface and data on the second, but the 3D digital collectibles icon may be shown in any orientation, including any of the orientations discussed above. Individual 3D digital collectibles icons may be arranged in a common orientation, or different orientations. The individual 3D digital collectibles icons may also be arranged in a list or other arrangement that allows a user to view the contents of pack 700.

According to an embodiment, a user may also select one of the 3D digital collectibles icons in pack 700 shown in FIG. 8a. The GUI will then display the selected 3D digital collectible and allow further user interaction, or may launch an interactive GUI such as is described in more detail in U.S. application filed Apr. 13, 2021 as U.S. application Ser. No. 17/229,430, titled “System And Method For Creating, Managing, And Displaying An Interactive Display For 3D Digital Collectibles,” hereby incorporated by reference in its entirety.

The 3D digital collectibles associated with the non-selected icons may not be revealed until the user selects the corresponding icon. A user need not open any pack immediately on purchase. Nor must a user select each of the icons of a pack within a single session. If a user selects none, one or more, but less than all of the icons in a pack, the 3D digital collectables associated with the non-selected icons will remain unrevealed to the user. However, these 3D digital collectables remain associated with the user account. A GUI associated with the user account profile (and other displays) may display a visual indication of the user's packs, and a visual indication of whether a pack has been opened or not. If a pack is not yet opened, one or more indicators may be presented via a GUI to indicate that pack status. If a pack has been opened, but not all of the 3D digital collectables of the pack have been revealed, one or more indicators may be presented via a GUI to indicate that pack status. Other visual indicators may be displayed to indicate the status of the packs and/or 3D digital collectables within a pack.

In some embodiments, media player 809 may automatically play the digital media file in the selected 3D digital collectible. Before, during and/or after the media player starts to play the digital media file, the system may display various data, metadata, context, scarcity indicator and/or other information or content relates to the selected digital collectable. This variety of media and data and the delayed reveal of the digital collectables creating an enjoyable and user experience and can add suspense to the process.

According to another embodiment, a user may request that the digital media files included in the 3D digital collectibles of pack 700 be played in a media player or separate window or pop-up. For example, a user may select the watch button 808 in the FIG. 8a embodiment, which may launch a media player in GUI 800, such as media player 809 in FIG. 8b. Media player 809 is described in more detail in a U.S. application filed Apr. 13, 2021 as U.S. application Ser. No. 17/229,455, titled “System And Method For Creating, Managing, And Displaying 3D Digital Collectibles,” hereby incorporated by reference in its entirety.

In an embodiment, media player 809 plays each of the digital media files in the selected (opened) 3D digital collectibles of pack 700 individually and/or in a continuous serial loop, either by sequentially playing the individual digital media files or by stitching together the individual digital media files into one file. In other embodiments, GUI may provide the user options to play particular digital media files, such as by showing individual links or icons, and may allow the user to control the playback.

In another embodiment, after a user selects watch button 808 in FIG. 8a, GUI 800 may sequentially display 3D digital collectibles 805a, 805b, and 805c and their respective digital media files. For example, GUI 800 may display a first 3D digital collectible 805a, automatically play a digital media file from the first 3D digital collectible 805a, then display a second 3D digital collectible 805b and automatically play a digital media file from the second 3D digital collectible 805b, and so on until each 3D digital collectible and digital media file has been displayed in pack 700.

In an embodiment, pack 700 may include a link creation button 807 for a user to create a link to pack 700 to allow other users to view the contents of pack 700. Other buttons, links, or interfaces may be provided.

In another embodiment, a pack 700 may itself include multiple packs of 3D digital collectibles. In such an embodiment, packs, rather than 3D digital collectibles, may be displayed in GUI 800 in FIG. 8a, and another GUI is rendered to display the 3D digital collectibles in the sub-packs. Packs containing sub-packs may be denoted by visual cues, such as shading, highlights, boxes surrounding the individual 3D digital collectibles of a sub-collection.

In another embodiment, the 3D digital collectibles of pack 700 may be hidden after the initial opening of the pack 700, as shown in FIG. 8c. In this embodiment, GUI 810 includes icons (e.g., 805a, 805b, and 805c) that include an indication that clicking on the icon will reveal a 3D digital collectible that is included in the pack. In some embodiments, clicking on an icon will result in the display of the underlying 3D digital collectible, either by replacing the icon 815a with a rendering of the 3D digital collectible (such as is shown in FIG. 8a by collectible 805a), or by making the 3D digital collectible more pronounced in a separate view.

In some embodiments, after an icon 815a is selected and replaced by a digital collectible 805a, digital collectible 805a remains visible. In this manner, by selecting each icon 815a, a view similar to that of FIG. 8b can be provided, where each icon 815a, b, and c is replaced by, for example, 3D digital collectibles 805a, 805b, and 805c. The collectibles may then be interacted with in the manner described above.

In exemplary embodiments, system 410 may include pack manager 429 that creates and manages packs. Pack manager interfaces with rendering engine 418 and display generator 416 to display the packs, intermediate GUI, and underlying 3D digital collectibles in the manner discussed above. Pack manager may assign a unique identifier to each pack. Data related to each pack may be stored as pack data 448. Such data includes relationships between pack identifiers and constituent 3D digital collectibles.

Pack manager 429 may assign 3D digital collectibles to packs. In some embodiments, the 3D digital collectibles may be randomly assigned to packs. In other embodiments, the 3D digital collectibles may be assigned according to data, such as event data, context data, metadata, series data, set data, or other data discussed herein. In other words, the 3D digital collectibles in a pack may have corresponding context data. For example, in a sports context, the 3D digital collectibles in a pack may each correspond to live entertainment events of a specific league, team, player, moves type, and/or score.

Processing Devices and Processors

In some embodiments, the platforms, systems, media, and methods described herein, including system 400, include a processing devices, processors, or use of the same. In further embodiments, the processing device includes one or more hardware central processing units (CPUs) or general purpose graphics processing units (GPUs) that carry out the device's functions. In still further embodiments, the processing device further comprises an operating system configured to perform executable instructions. In some embodiments, the processing device is optionally connected a computer network. In further embodiments, the processing device is optionally connected to the Internet such that it accesses the World Wide Web. In still further embodiments, the processing device is optionally connected to a cloud computing infrastructure. In other embodiments, the processing device is optionally connected to an intranet. In other embodiments, the processing device is optionally connected to a data storage device. In accordance with the description herein, suitable processing devices include, by way of non-limiting examples, cloud computing resources, server computers, server clusters, desktop computers, laptop computers, notebook computers, sub-notebook computers, netbook computers, netpad computers, handheld computers, mobile smartphones, and tablet computers. In some embodiments, the processing device includes an operating system configured to perform executable instructions. The operating system is, for example, software, including programs and data, which manages the device's hardware and provides services for execution of applications. Those of skill in the art will recognize that suitable server operating systems include, by way of nonlimiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft Windows Phone® OS, Microsoft Windows Mobile® OS, Linux®, and Palm® WebOS®. In some embodiments, the processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the processing device is not powered. In further embodiments, the non-volatile memory comprises flash memory. In some embodiments, the nonvolatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein. In some embodiments, the processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active matrix OLED (AMOLED) display. In some embodiments, the processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In still further embodiments, the input device is a combination of devices such as those disclosed herein.

Referring to FIG. 4, in an exemplary platform 400, an exemplary system 410 is programmed or otherwise configured to, for example, dynamically load data provider connector modules and/or request, procure, process, analyze, persist and/or provide one or more data records. In this embodiment, the system 400 includes a processor 412 (also known as a central processing unit (CPU) and “computer processor”), which can be a single core or multi core processor, or a plurality of processors for parallel processing. System 410 also includes memory or memory location (e.g., random-access memory, read-only memory, flash memory), system storage 430 (e.g., hard disk), a communication interface (e.g., network adapter) for communicating with one or more other systems, and peripheral devices, such as cache, other memory, data storage and/or electronic display adapters. The memory, system storage 430, network interface and peripheral devices are in communication with the CPU 412 through a communication bus, such as a motherboard. The system storage 430 can be a data storage unit (or data repository) for storing data. System 410 can be operatively coupled to a computer network (“network”) with the aid of the communication interface. The network can be the Internet, an internet and/or extranet, or an intranet and/or extranet that is in communication with the Internet. The network in some cases is a telecommunication and/or data network. The network can include one or more computer servers, server clusters and/or distributed computing resources, providing, for example cloud computing. The network, in some cases with the aid of the system 410, can implement a peer-to-peer network, which may enable devices coupled to the device 501 to behave as a client or a server.

In some embodiments, the CPU 412 can execute a sequence of machine-readable instructions, which can be embodied in a program or software. The instructions may be stored in a memory location, such as the memory. The instructions can be directed to the CPU 412, which can subsequently program or otherwise configure the CPU 412 to implement methods of the present disclosure. The CPU 412 can be part of a circuit, such as an integrated circuit. One or more other components of the system 410 can be included in the circuit. In some cases, the circuit is an application specific integrated circuit (ASIC) or a field programmable gate array (FPGA).

In some embodiments, the system storage 430 can store files such as drivers, libraries and saved programs. The system storage 430 can store user data, e.g., user preferences and user programs. The system 410 in some cases can include one or more additional data storage units that are external, such as located on a remote server, remote server cluster, network attached storage, or the like, that is in communication through an intranet or the Internet. In some embodiments, methods as described herein can be implemented by way of machine (e.g., computer processor) executable code stored on an electronic storage location of the system 410, such as, for example, on the memory or system storage 430. The machine executable or machine readable code can be provided in the form of software. During use, the code can be executed by the CPU 412. In some cases, the code can be retrieved from the system storage 430 and stored on the memory for ready access by the CPU 412. In some situations, the system storage 430 can be precluded, and machine-executable instructions are stored on memory. In some embodiments, the code is pre-compiled. In some embodiments, the code is compiled during runtime. The code can be supplied in a programming language that can be selected to enable the code to execute in a precompiled or as-compiled fashion.

In some embodiments, the system 410 can include or be in communication with an electronic display 470. In some embodiments, the electronic display 470 provides a user interface or GUI.

Non-Transitory Computer Readable Storage Medium

In some embodiments, the platforms, systems, media, and methods disclosed herein include one or more non-transitory computer readable storage media encoded with a program including instructions executable by the operating system of an optionally networked processing device. In further embodiments, a computer readable storage medium is a tangible component of a processing device. In still further embodiments, a computer readable storage medium is optionally removable from a processing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

Computer Program

In some embodiments, the platforms, systems, media, and methods disclosed herein include at least one computer program, or use of the same. A computer program includes a sequence of instructions, executable in the processing device's CPU, written to perform one or more specified tasks. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages. The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof

Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language OiML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of nonlimiting examples, Adobe® Flash®, HTML 5, Apple® QuickTime®, Microsoft® Silverlight®, Java™, and Unity®.

Mobile Application

In some embodiments, a computer program includes a mobile application provided to a mobile processing device. In some embodiments, the mobile application is provided to a mobile processing device at the time it is manufactured. In other embodiments, the mobile application is provided to a mobile processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, Javascript, Pascal, Object Pascal, Python™, Ruby, VB .NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, Mobi-Flex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of nonlimiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

Databases

In some embodiments, the platforms, systems, media, and methods disclosed herein include one or more databases, or use of the same. In view of the disclosure provided herein, those of skill in the art will recognize that many databases are suitable for storage and retrieval of data, such as digital media collectibles described herein. In various embodiments, suitable databases include, by way of non-limiting examples, relational databases, nonrelational databases, object oriented databases, object databases, entity-relationship model databases, associative databases, and XML databases. In some embodiments, a database is web-based. In still further embodiments, a database is cloud computing-based. In other embodiments, a database is based on one or more local computer storage devices.

Various methods have been described herein to generate, maintain, and display 3D digital collectibles, including methods using exemplary steps. It may be understood that more or less steps may be included, and that the illustrated steps are merely non-limiting examples. Nor is the order in which the steps are presented/described indicative of any set or requisite order that must be followed. It should be appreciated that various prompts, cues, buttons, and/or other graphical/visual interactive elements may be presented to the user together with one or more of these steps. _Steps depicted herein may correspond to instructions stored in computer readable storage medium which can be executed by one or more processors of computing components described herein, for example as part of computing components disclosed herein.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. A computer system for managing access to an offering of digital collectibles based on stored eligibility criteria, comprising:
at least one processor; and
a computer-readable storage medium having instructions stored thereon which are executable by the at least one processor and which, when executed, cause the computing system to perform operations comprising:
providing a user database containing user account records, wherein a first user account record includes first user-specific data indicating a first user with a corresponding collection of digital collectibles and prior actions taken by the first user relating to digital collectibles, the prior actions indicating that the first user acquired a first instance of a first digital collectible by completing a challenge distinct from purchasing the first instance of the first digital collectible;
creating a digital collectible offering comprising one or more second digital collectibles, the digital collectible offering being initially accessible by a set of users that includes the first user and a second user that acquired a second instance of the first digital collectible by purchasing the second instance of the first digital collectible without completing the challenge;
creating and storing eligibility criteria for the digital collectible offering in a blockchain that corresponds to the one or more second digital collectibles;
displaying the digital collectible offering for the one or more second digital collectibles that correspond to the blockchain that stores the eligibility criteria;
comparing the eligibility criteria stored in the blockchain that corresponds to the one or more second digital collectibles to at least some of the first user-specific data;
determining that the first user meets the eligibility criteria stored in the blockchain that corresponds to the one or more second digital collectibles based on the prior actions indicating that the first user acquired the first instance of the first digital collectible by completing the challenge distinct from purchasing the first instance of the first digital collectible; and
in response to determining that the first user meets the eligibility criteria stored in the blockchain that corresponds to the one or more second digital collectibles, restricting access to the computing system to a subset of the set of users by allowing the first user that acquired the first instance of the first digital collectible by completing the challenge distinct from purchasing the first instance of the first digital collectible to participate in the digital collectible offering for the one or more second digital collectibles that correspond to the blockchain that stores the eligibility criteria and disallowing the second user that acquired the second instance of the first digital collectible by purchasing the second instance of the first digital collectible without completing the challenge from participating in the digital collectible offering for the one or more second digital collectibles that correspond to the blockchain that stores the eligibility criteria.

2. The computer system of claim 1, wherein the eligibility criteria comprises a required collector score.

3. The computer system of claim 1, wherein the eligibility criteria comprises a required collector score, and the first user-specific data comprises a first user collector score determined based on properties of the first user's collection of digital collectibles.

4. The computer system of claim 1, wherein the eligibility criteria comprises a required collector score, and the first user-specific data comprises a first user collector score determined based on properties of the first user's collection of digital collectibles and the prior actions taken by the first user relating to digital collectibles.

5. The computer system of claim 1, wherein the eligibility criteria comprises a required collector score, and the first user-specific data comprises a first user collector score determined based on a stored set of collector score rules.

6. The computer system of claim 5, wherein the collector score rules includes rules that specify different point values for different types of digital collectibles in the first user's collection of digital collectibles and different points values for different prior actions in the first user's prior actions.

7. The computer system of claim 5, comprising a first digital wallet associated with the first user and the determination of a first user's collector score includes a determination of properties of the digital collectibles associated with the first digital wallet.

8. The computer system of claim 1, wherein the eligibility criteria for the offering comprises a multi-factor score, including two or more factors, the factors including how many digital collectibles are associated with a user, what type of digital collectibles are associated with a user, a user's rewards point balance, a user's monetary balance, and whether the user has completed particular challenges.

9. The computer system of claim 1, wherein the eligibility criteria for the offering comprises a multi-factor score, including three or more factors, the factors including how many digital collectibles are associated with a user, what type of digital collectibles are associated with a user, a user's rewards point balance, a user's monetary balance, and whether the user has completed particular challenges.

10. The computer system of claim 1, wherein the eligibility criteria for the offering comprises a multi-factor score, including two or more factors and a weighting of the factors.

11. The computer system of claim 1, wherein the eligibility criteria is based on a collector score of the first user, wherein the collector score of the first user is based on the digital collectibles the first user owns at a time the collector score is to be calculated, wherein each digital collectible is assigned a point value based on attributes of the digital collectible, the attributes including one or more of a type, rarity, and series of the digital collectible.

12. The computer system of claim 1, wherein the eligibility criteria is based on a collector score of the first user, wherein the collector score of the first user is based on the digital collectibles the first user owns at a time the collector score is to be calculated, wherein each digital collectible is assigned a point value based on how the first user acquired the digital collectible, including whether the first user obtained the digital collectible by purchase of the digital collectible from a primary market sale, by purchase of the digital collectible from a secondary market sale, by obtaining the digital collectible as a challenge reward, or by obtaining the digital collectible through a promotion.

13. The computer system of claim 1, wherein the eligibility criteria is based on a collector score of the first user, wherein the collector score of the first user is based on the digital collectibles the first user owns at a time the collector score is to be calculated and a bonus award, wherein the bonus award is based on one or more bonus criteria, including bonuses for holding a particular set of digital collectibles, a user status, or a reward point balance.

14. A method comprising:
providing, by one or more processors, a user database containing user account records, wherein a first user account record includes first user-specific data indicating a first user with a corresponding collection of digital collectibles and prior actions taken by the first user relating to digital collectibles, the prior actions indicating that the first user acquired a first instance of a first digital collectible by completing a challenge distinct from purchasing the first instance of the first digital collectible;
creating, by the one or more processors, a digital collectible offering comprising one or more second digital collectibles, the digital collectible offering being initially accessible by a set of users that includes the first user and a second user that acquired a second instance of the first digital collectible by purchasing the second instance of the first digital collectible without completing the challenge;
by the one or more processors, creating and storing eligibility criteria for the digital collectible offering in a blockchain that corresponds to the one or more second digital collectibles;
displaying, by the one or more processors, the digital collectible offering for the one or more second digital collectibles that correspond to the blockchain that stores the eligibility criteria;
comparing, by the one or more processors, the eligibility criteria stored in the blockchain that corresponds to the one or more second digital collectibles to at least some of the first user-specific data;
determining, by the one or more processors, that the first user meets the eligibility criteria stored in the blockchain that corresponds to the one or more second digital collectibles based on the prior actions indicating that the first user acquired the first instance of the first digital collectible by completing the challenge distinct from purchasing the first instance of the first digital collectible; and
by the one or more processors and in response to determining that the first user meets the eligibility criteria stored in the blockchain that corresponds to the one or more second digital collectibles, restricting access to a computing system to a subset of the set of users by allowing the first user that acquired the first instance of the first digital collectible by completing the challenge distinct from purchasing the first instance of the first digital collectible to participate in the digital collectible offering for the one or more second digital collectibles that correspond to the blockchain that stores the eligibility criteria and disallowing the second user that acquired the second instance of the first digital collectible by purchasing the second instance of the first digital collectible without completing the challenge from participating in the digital collectible offering for the one or more second digital collectibles that correspond to the blockchain that stores the eligibility criteria.

15. A non-transitory machine-readable medium comprising instructions that, when executed by one or more processors of a machine, cause the machine to perform operations comprising:
providing a user database containing user account records, wherein a first user account record includes first user-specific data indicating a first user with a corresponding collection of digital collectibles and prior actions taken by the first user relating to digital collectibles, the prior actions indicating that the first user acquired a first instance of a first digital collectible by completing a challenge distinct from purchasing the first instance of the first digital collectible;
creating a digital collectible offering comprising one or more second digital collectibles, the digital collectible offering being initially accessible by a set of users that includes the first user and a second user that acquired a second instance of the first digital collectible by purchasing the second instance of the first digital collectible without completing the challenge;
creating and storing eligibility criteria for the digital collectible offering in a blockchain that corresponds to the one or more second digital collectibles;
displaying the digital collectible offering for the one or more second digital collectibles that correspond to the blockchain that stores the eligibility criteria;
comparing the eligibility criteria stored in the blockchain that corresponds to the one or more second digital collectibles to at least some of the first user-specific data;
determining that the first user meets the eligibility criteria stored in the blockchain that corresponds to the one or more second digital collectibles based on the prior actions indicating that the first user acquired the first instance of the first digital collectible by completing the challenge distinct from purchasing the first instance of the first digital collectible; and
in response to determining that the first user meets the eligibility criteria stored in the blockchain that corresponds to the one or more second digital collectibles, restricting access to the machine to a subset of the set of users by allowing the first user that acquired the first instance of the first digital collectible by completing the challenge distinct from purchasing the first instance of the first digital collectible to participate in the digital collectible offering for the one or more second digital collectibles that correspond to the blockchain that stores the eligibility criteria and disallowing the second user that acquired the second instance of the first digital collectible by purchasing the second instance of the first digital collectible without completing the challenge from participating in the digital collectible offering for the one or more second digital collectibles that correspond to the blockchain that stores the eligibility criteria.
